(19) United States
(12) Patent Application Publication
(10) Pub. No.: US 2013/0195013 A1
(43) Pub. Date: Aug. 1, 2013

(54) APPARATUS AND METHOD FOR CONTROLLING IN-DEVICE COEXISTENCE INTERFERENCE IN WIRELESS COMMUNICATION SYSTEM

(71) Applicant: Pantech Co., Ltd., Seoul (KR)

(72) Inventors: Jae Hyun AHN, Seoul (KR); Ki Bum Kwon, Seoul (KR); Myung Cheul Jung, Seoul (KR); Kang Suk Huh, Seoul (KR)

(73) Assignee: Pantech Co., Ltd., Seoul (KR)

(21) Appl. No.: 13/750,509

(22) Filed: Jan. 25, 2013

(30) Foreign Application Priority Data
Jan. 27, 2012 (KR) 10-2012-0008558

(51) Int. Cl. H04W 24/02

(52) U.S. Cl. CPC H04W 24/02
USPC 370/328

(57) ABSTRACT

Method and apparatus of user equipment controlling In-Device Coexistence (IDC) interference in a wireless communication system are described in accordance with the present invention. The present invention comprises receiving an IDC indication request from an eNodeB (eNB) when a point of time at which an IDC indication for sending IDC-related information is triggered is different from a point of time at which load balancing is applied, sending the requested IDC indication to the eNB and receiving an In-device Coexistence interference cOordination (ICO) operation order determined based on the IDC indication from the eNB.

### CROSS-REFERENCE TO RELATED APPLICATION

This application claims priority from and the benefit of priority of Korean Patent Application No. 10-2012-0008558 filed on Jan. 27, 2012, which is incorporated by reference in their entirety herein for all purposes.

### BACKGROUND

1. Field

The present invention relates to a wireless communication system and, more particularly, to an apparatus and method for controlling In-Device Coexistence interference in a wireless communication system.

2. Discussion of the Background

In order to support an increased transmission capacity, 3rd generation partnership project (3GPP) long term evolution (LTE) or IEEE 802.16m needs a extended bandwidth thereof up to 20 MHz or more in recent years. The bandwidth may need to increase so as to increase the transmission capacity, but supporting a large bandwidth even when a required service level is low may cause large power consumption. With regard to it, technical trade-off may occur.

Also, in recent years, as functions of a single terminal have been advanced and complicated, the user can communicate with a plurality of network systems simultaneously by using only the single terminal and user convenience has increased. However, when one terminal performs communication on a plurality of network system bands simultaneously, In-Device Coexistence interference (IDC) may occur. The in-device coexistence interference (IDC) means interference when transmission in any one frequency band interferes in reception in another frequency band. For example, the in-device coexistence interference may occur between a Bluetooth system band and a 802.16 system band when one terminal supports both a Bluetooth system and a 802.16 system.

The in-device coexistence interference may occur primarily when a spacing interval of a frequency band boundary of a heterogeneous network system is not sufficiently large, and recent wireless system needs a solution to avoid or control in-device coexistence interference.

### SUMMARY

An object of the present invention is to provide an apparatus and method for controlling In-Device Coexistence (IDC) interference.

Another object of the present invention is to provide a method and apparatus in is which an eNB requests IDC interference and information from UE.

Yet another object of the present invention is to provide a method and apparatus for transmitting and receiving an indication operation related to IDC interference.

According to an example of the present invention, a method of user equipment controlling In-Device Coexistence (IDC) interference in a wireless communication system comprises receiving an IDC indication request from an eNodeB (eNB) when a point of time at which an IDC indication for sending IDC-related information is triggered is different from a point of time at which load balancing is applied, sending the requested IDC indication to the eNB and receiving an In-device Coexistence interference cOordination (ICO) operation order determined based on the IDC indication from the eNB.

According to another example of the present invention, a method of an eNB controlling In-Device Coexistence (IDC) interference in a wireless communication system comprises determining whether or not to make an IDC indication request based on a point of time at which an IDC indication for sending IDC-related information is triggered is different from a point of time at which load balancing is applied, requesting the IDC indication from User Equipment (UE) based on the determination, receiving the requested IDC indication from the UE, determining an appropriate ICO operation based on the IDC indication and sending an order for the determined ICO operation to the UE.

According to yet another example of the present invention, a user equipment controlling In-Device Coexistence (IDC) interference in a wireless communication system comprises a reception unit configured to receive an IDC indication request from an eNB when a point of time at which an IDC indication for sending IDC-related information is triggered is different from a point of time at which load balancing is applied and a transmission unit is configured to send the requested IDC indication to the eNB. The reception unit may receive an In-device Coexistence interference Coordination (ICO) operation order determined based on the IDC indication from the eNB.

According to yet another example of the present invention, an eNodeB (eNB) controlling In-Device Coexistence (IDC) interference in a wireless communication system comprises an IDC indication request determination unit configured to determine whether or not to make an IDC indication request based on a point of time at which an IDC indication for sending IDC-related information is triggered is different from a point of time at which load balancing is applied, a transmission unit configured to request the IDC indication from User Equipment (UE) based on the determination, a transmission unit configured to receive the requested IDC indication from the UE and an ICO determination unit configured to determine an appropriate In-device Coexistence interference Coordination (ICO) operation based on the IDC indication. The transmission unit may send an order for the determined ICO operation to the UE.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 illustrates a wireless communication system according to exemplary embodiments of the present invention.

FIG. 2 is an explanatory diagram describing in-device coexistence interference.

FIG. 3 is an example illustrating the in-device coexistence interference from an industrial, scientific and medical transmitter to an LTE receiver.

FIG. 4 is an example in which a band is divided into an ISM band and an LTE band on a frequency band.

FIG. 5 is an explanatory diagram illustrating one example of alleviating the in-device coexistence interference by using an FDM scheme according to the present invention.

FIG. 6 is an explanatory diagram illustrating another example of alleviating the in-device coexistence interference by using the FDM scheme according to the present invention.

FIGS. 7 and 8 are explanatory diagrams illustrating one example of alleviating the in-device coexistence interference by using a power control scheme according to the present invention.

FIG. 9 is an explanatory diagram illustrating one example of alleviating the in-device coexistence interference according to the present invention.

FIG. 10 is an explanatory diagram illustrating one example of transmission/reception timings on time axes in the LTE band and the ISM band using the TDM scheme according to the present invention.

FIG. 11 is a diagram illustrating another example of alleviating the in-device coexistence interference according to the present invention.

FIG. 12 is a diagram illustrating yet another example of alleviating the in-device coexistence interference according to the present invention.

FIG. 13 is a diagram illustrating yet another example of alleviating the in-device coexistence interference according to the present invention.

FIG. 14 shows a case where UE receives an interference signal within the device.

FIG. 15 shows an example of a proximity indication operation which is applied to is the present invention.

FIG. 16 is a flowchart illustrating an example of the operations of an eNB and UE which performs In-Device Coexistence interference control in accordance with the present invention.

FIG. 17 shows an example in which a frequency band including a possibility that IDC interference may exist is indicated to which the present invention is applied.

FIG. 18 shows an example in which UE performs measurement including IDC interference or measurement not including IDC interference in accordance with the present invention.

FIG. 19 is a flowchart illustrating another example of the operations of an eNB and UE for performing ICO in accordance with the present invention.

FIG. 20 is a flowchart illustrating an example of the operation of UE for performing ICO in accordance with the present invention.

FIG. 21 is a flowchart illustrating an example of the operation of an eNB for performing ICO in accordance with the present invention.

FIG. 22 is a block diagram of an apparatus for transmitting and receiving information on IDC interference in accordance with an example of the present invention.

### DETAILED DESCRIPTION OF THE ILLUSTRATED EMBODIMENTS

Hereinafter, in this specification, some exemplary embodiments will be described in detail with reference to the accompanying drawings. In adding reference numerals to components throughout the drawings, it is to be noted that like reference numerals designate like components even though components are shown in different drawings. Further, in describing the is present invention, well-known functions or constructions will not be described in detail since they may unnecessarily obscure the understanding of the present invention.

Further, in describing components of the specification, terms such as first, second, A, B, (a), (b), and like may be used. These terms are just used to discriminate the components from other components and a property, an order, or a sequence of the corresponding component is not limited by the term. It will be understood that when an element is simply referred to as being ‘connected to’ or ‘coupled to’ another element without being ‘directly connected to’ or ‘directly coupled to’ another element in the present description, it may be ‘directly connected to’ or ‘directly coupled to’ another element or be connected to or coupled to another element, having the other element intervening there between.

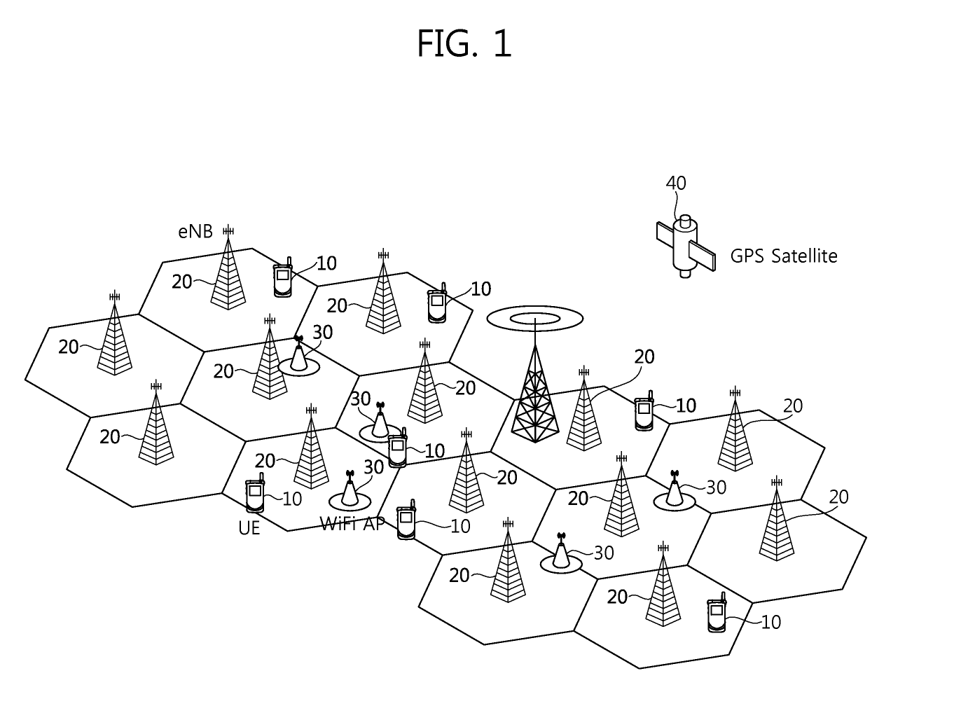

FIG. 1 illustrates a wireless communication system according to exemplary embodiments of the present invention.

Referring to FIG. 1, the wireless communication system is widely placed in order to provide various communication services including voice, packet, data, and the like, and includes a terminal (also may called as a user equipment (UE)) 10, a base station (BS, or called as a evolved NodeB (eNB)) 20, a wireless LAN access point (AP) 30, a global positioning system (GPS) 40, and a satellite. Herein, a wireless LAN is a device supporting IEEE 802.11 technology which a wireless standard and the IEEE 802.11 may be mixed with a WiFi system.

The UE 10 may be positioned in coverage of a plurality of networks including a cellular network, a wireless LAN broadcast network, a satellite system, and the like. The UE 10 is provided with a plurality of wireless transceivers in order to access various networks and various services regardless of place and time. For example, a smart phone is provided with long term evolution (LTE), WiFi Bluetooth transceiver, and a GPS receiver.

Hereinafter, a downlink (DL) indicates communication from the eNB 20 and an uplink (UL) indicates communication from the UE 10 to the eNB 20. In the downlink, a transmitter may be a part of the eNB 20 and a receiver may be a part of the UE 10. In the uplink, the transmitter may be a part of the UE 10 and a receiver may be a part of the eNB 20.

The UE 10 may be fixed or have mobility, and may be called other terms such as a mobile station (MS), a user terminal (UT), a subscriber station (SS), a mobile terminal (MT), a wireless device, and the like. The eNB 20 indicates a fixed station that communicates with the UE 10 and may be called other terms such as a base station (BS), a base transceiver system (BTS), an access point, a femto base station (BS), a relay, and the like.

Multiple access techniques applied to the wireless communication system are not limited. Various multiple access techniques such as CDMA (Code Division Multiple Access), TDMA (Time Division Multiple Access), FDMA (Frequency Division Multiple Access), OFDMA (Orthogonal Frequency Division Multiple Access), SC-FDMA (Single Carrier-FDMA), OFDM-FDMA, OFDM-TDMA, and OFDM-CDMA may be used. In uplink transmission and downlink transmission, a time division duplex (TDD) scheme in which transmission is performed by using different times may be used or a frequency division duplex (FDD) scheme in which transmission is performed by using different frequencies may be used.

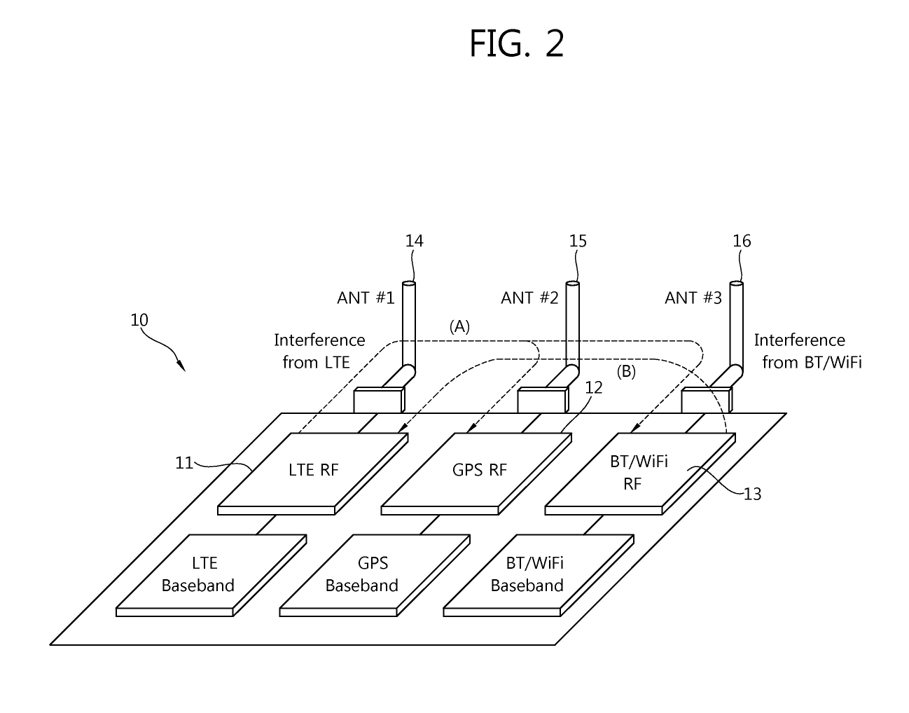

FIG. 2 is an explanatory diagram describing in-device coexistence interference.

Referring to FIG. 2, the UE 10 includes an LTE RF 11, a GPS RF 12, and a Bluetooth/WiFi RF 13. Transceiving antennas 14, 15, and 16 are connected to the respective RFs. That is, various types of RFs are closely mounted in one device platform. Herein, transmission power of one RF may be much larger than a reception power level into another RF receiver. In this case, if an interval in frequency between the RFs is not sufficient and a filtering is technique is not supported, a transmission signal of any RF may cause remarkable interference in a receiver of another RF within the device. For example, ‘A’ is an example in which the transmission signal of the LTE RF 11 causes the in-device coexistence interference in the GPS RF 12 and the Bluetooth/WiFi RF 13 and ‘B’ is an example in which the transmission signal of the Bluetooth/WiFi RF 13 causes the in-device coexistence interference in the LTE RF 11.

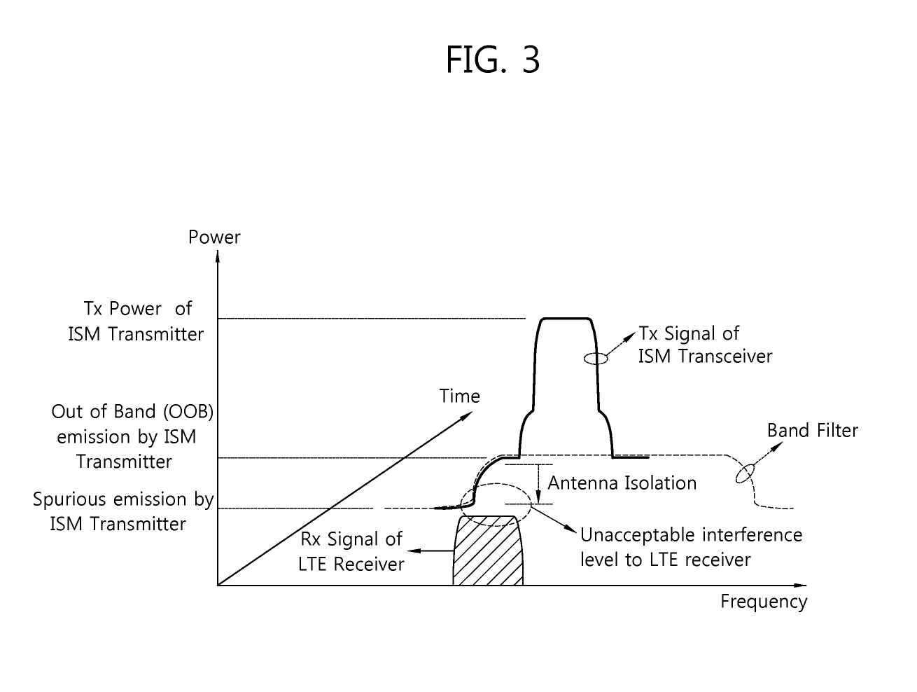

FIG. 3 is an example illustrating the in-device coexistence interference from an industrial, scientific and medical (ISM) transmitter to an LTE receiver. The ISM band indicates a band which may be arbitrarily used without authorizing the use in industrial, scientific, and medical fields.

Referring to FIG. 3, a band of a signal received by the LTE receiver overlaps with a band of a transmission signal of the ISM transmitter. In this case, the in-device coexistence interference may occur.

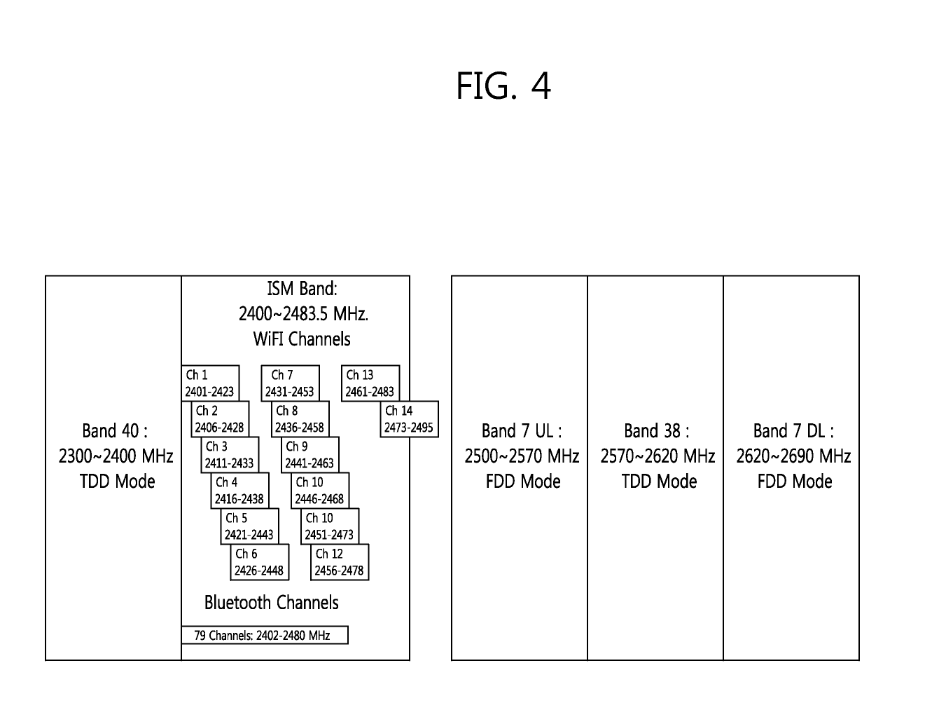

FIG. 4 is an example in which a band is divided into an ISM band and an LTE band on a frequency band.

Referring to FIG. 4, a band 40, a band 7, and a band 38 are LTE bands. The band 40 occupies a band in the range of 2300 to 2400 MHz in a TDD mode and the band 7 occupies a band in the range of 2500 to 2570 MHz as the uplink in an FDD mode. In addition, the band 38 occupies a band in the range of 2570 to 2620 MHz in the TDD mode. Meanwhile, the ISM band is used as a WiFi channel and a Bluetooth channel, and occupies a band in the range of 2400 to 2483.5 MHz. Herein, a condition in which the in-device coexistence interference occurs is illustrated in Table 1 below.

TABLE 1

| Interference band | Pattern of interference |
|---|---|
| Band 40 | ISM Tx -> LTE TDD DL Rx |
| Band 40 | LTE TDD UL Tx -> ISM Rx |
| Band 7 | LTE FDD UL Tx -> ISM Rx |
| Band 7/13/14 | LTE FDD UL Tx -> GPS Rx |

Referring to Table 1, a mark of ‘a->b’ in the interference pattern illustrates a is condition in which a transmitter a causes the in-device coexistence interference to a receiver b. Therefore, in the band 40, the ISM transmitter causes the in-device coexistence interference to an LTE-band downlink TDD receiver (LTE DL TDD Rx). The in-device coexistence interference may be alleviated to some extent by a filtering scheme, but is not sufficient to alleviate the in-device coexistence interference. When a frequency division multiplex (FDM) scheme is additionally applied to the filtering scheme, the in-device coexistence interference may be more efficiently alleviated.

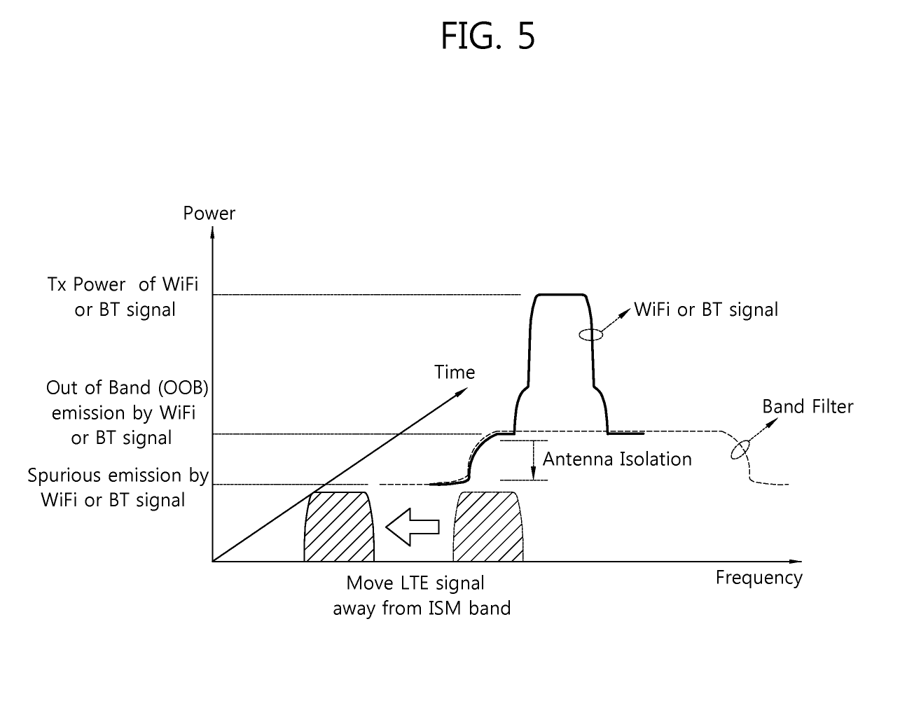

FIG. 5 is an explanatory diagram illustrating one example of alleviating the in-device coexistence interference by using an FDM scheme according to the present invention.

Referring to FIG. 5, the LTE band may be moved so as to prevent the LTE band and the ISM band from overlapping with each other. As a result, a handover of the terminal is induced from the ISM band. However, to this end, a method in which legacy measurement or new signaling accurately triggers a mobility procedure or a radio link failure (RLF) procedure is required. Alternatively, a part which becomes a problem associated with the ISM in the LTE band may be avoided through a filtering or resource allocation technique. Alternatively, overlapping interference may be avoided with respect to a case in which LTE carriers are compiled through a procedure of reconfiguring a set of used carriers.

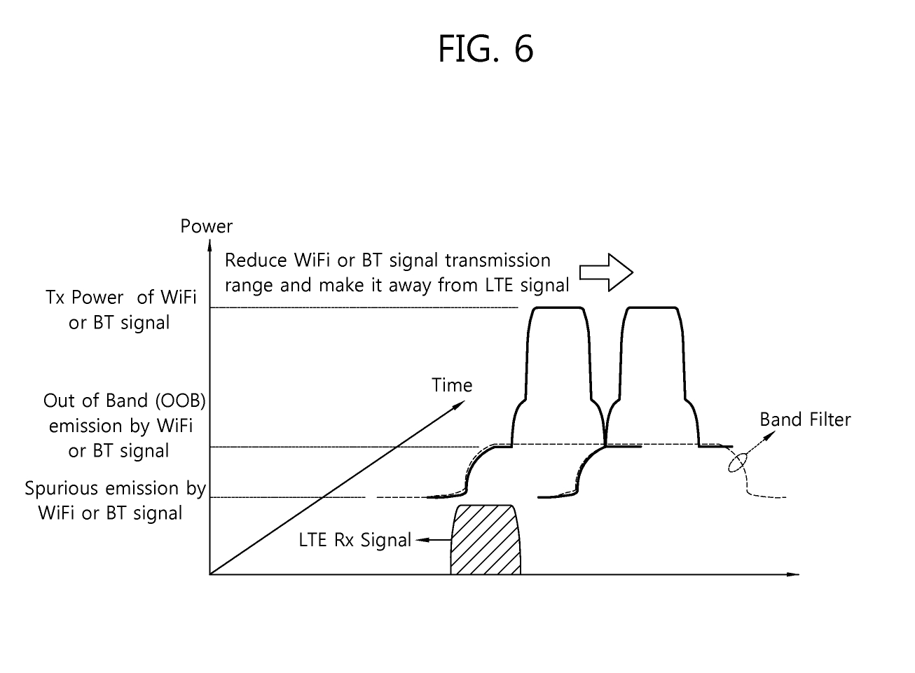

FIG. 6 is an explanatory diagram illustrating another example of alleviating the is in-device coexistence interference by using the FDM scheme according to the present invention.

Referring to FIG. 6, the ISM band may be reduced and moved so as to be spaced apart from the LTE band. However, in this scheme, backward compatibility problem may occur. In the case of the Bluetooth, the backward compatibility problem may be resolved due to an adaptive frequency hopping mechanism to some extent, but in the case of the WiFi, it may be difficult to resolve the backward compatibility problem.

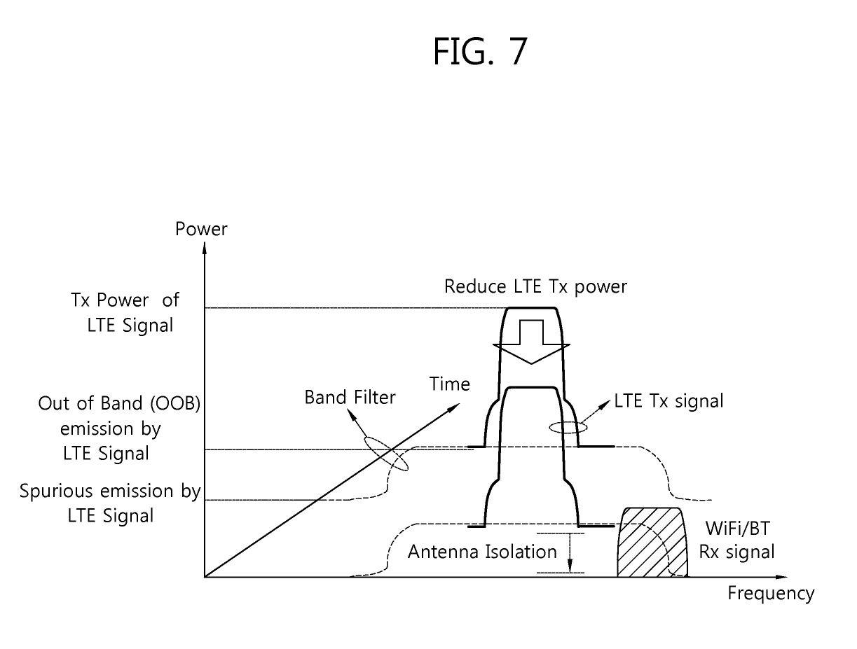

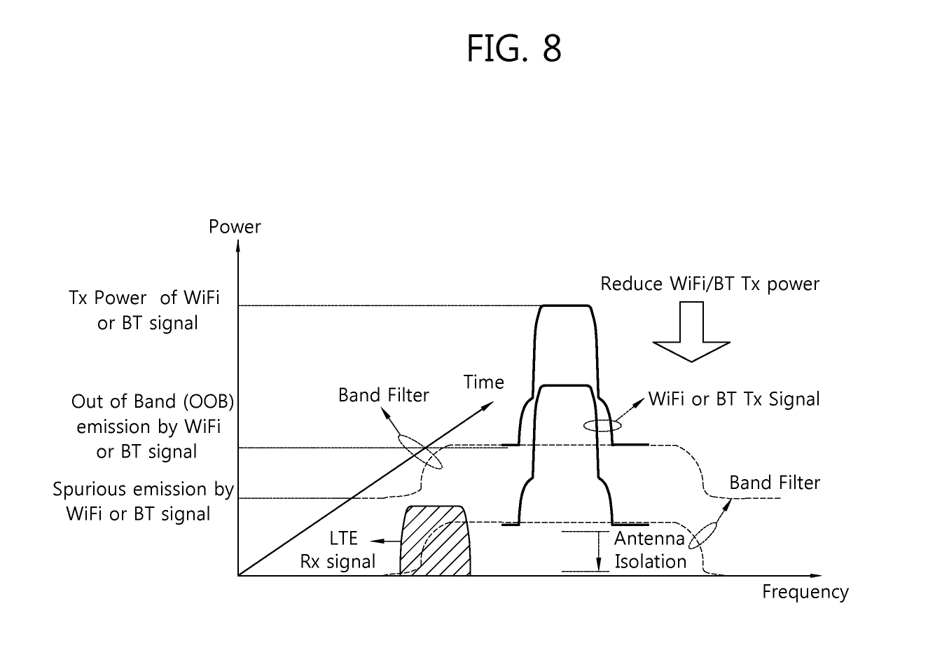

FIGS. 7 and 8 are explanatory diagrams illustrating one example of alleviating the in-device coexistence interference by using a power control (PC) scheme according to the present invention.

Referring to FIG. 7, the terminal avoids the in-device coexistence interference by lowering transmission power of the LTE signal by a predetermined level to improve reception quality of the ISM band and referring to FIG. 8, the terminal avoids the in-device coexistence interference by lowering transmission power of the ISM band by a predetermined level to improve reception quality of the LTE signal.

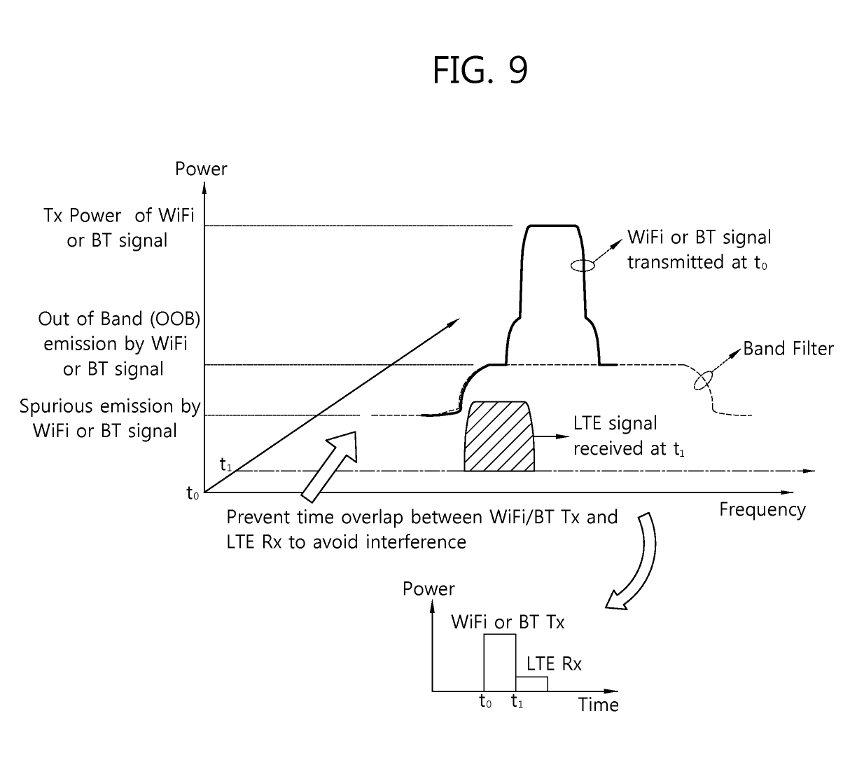

FIG. 9 is an explanatory diagram illustrating one example of alleviating the in-device coexistence interference according to the present invention.

Referring to FIG. 9, when a reception time of the LTE signal is prevented from overlapping with a transmission time in the ISM band, the in-device coexistence interference may be avoided. For example, when the signal in the ISM band is transmitted at t₀, the LTE signal is received at t₁.

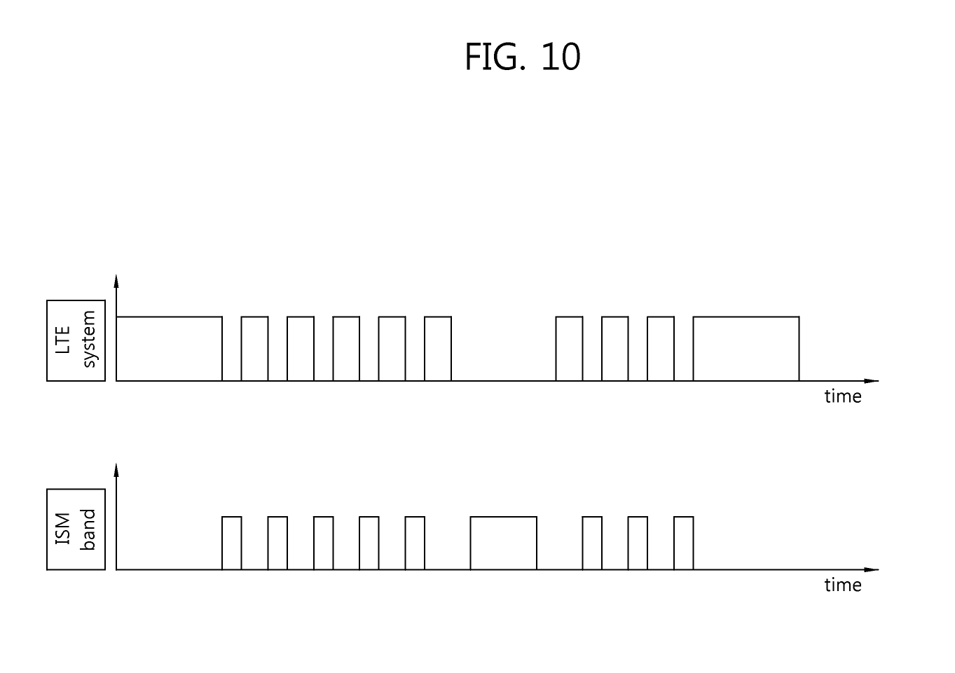

FIG. 10 is an explanatory diagram illustrating one example of transmission/reception timings on time axes in the LTE band and the ISM band using the TDM scheme according to the present invention.

Referring to FIG. 10, the in-device coexistence interference may be avoided without movement between the LTE band and the ISM band by using the scheme of FIG. 9.

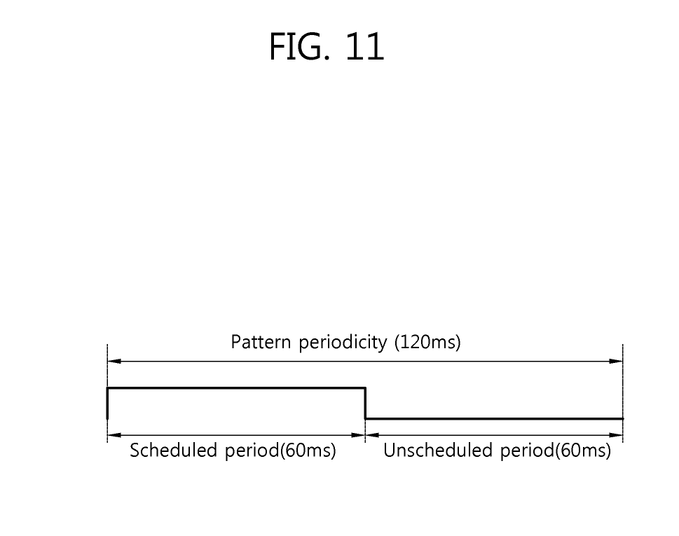

FIG. 11 is a diagram illustrating another example of alleviating the in-device coexistence interference according to the present invention.

Referring to FIG. 11, a predetermined pattern periodicity interval is divided into a scheduled period interval and an unscheduled period interval to avoid the in-device coexistence interference by the TDM scheme based on discontinuous reception (DRX).

Mutual interference between the LTE and the ISM is avoided by preventing the LTE from being transmitted within the unscheduled period interval. However, primary LTE transmission such as random access and hybrid automatic repeat request (HARQ) retransmission may be permitted even within the scheduled period interval.

Mutual interference between the LTE and the ISM is avoided by preventing the ISM from being transmitted and permitting the LTE to be transmitted within the scheduled period interval. The primary ISM transmission such as Beacon or WiFi may be permitted even within the scheduled period interval, similarly as the unscheduled period interval.

The LTE transmission may be prevented in order to protect the primary ISM transmission. Special signaling for protecting the primary ISM transmission such as Beacon may be added. As one example, a period of the Beacon signaling and information on a subframe offset may be added. In this case, the subframe offset number and the system frame number may be determined based on ‘0’. The system frame number may have one of ‘0’ to ‘1023’ by the unit of a radio frame in the LTE system. One radio frame is constituted by ten subframes. When the corresponding subframe offset number and system frame number are known, an accurate frame position may be known in the corresponding system. The corresponding period or offset may be is used as information to choose proper DRX period of DRX offset.

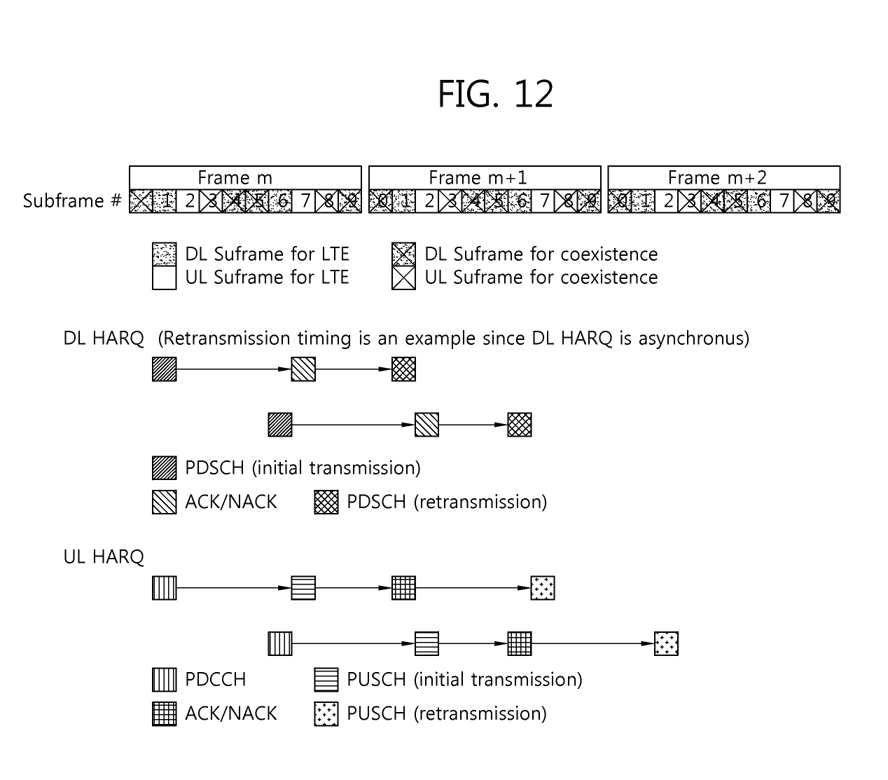

FIG. 12 is a diagram illustrating yet another example of alleviating the in-device coexistence interference according to the present invention.

Referring to FIG. 12, by the TDM scheme based on the HARQ, a retransmission signal is preferably protected when data is transmitted based on the HARQ. Herein, being protected represents that retransmission is achieved without fail. If retransmission is not achieved in order to alleviate or avoid the in-device coexistence interference in the TDM scheme, the performance of the system will remarkably deteriorate. Based on this point, a transmission pattern is determined by considering a retransmission period. For DL transmission, subframes 1 and 6 are reserved in advance and for UL transmission, subframes 2 and 7 are reserved. These are called scheduled subframes. Unscheduled subframes for alleviating the in-device coexistence interference are not used in transmission in order to protect the ISM band.

Even in a scheme based on the HARQ similarly as a scheme based on DRX, the subframes reserved for transmission may be prevented from being transmitted in order to transmit a primary signal in the ISM. On the contrary, even in the unscheduled subframes, primary messages such as random access, system information, and a paging signal may be permitted to be transmitted.

The pattern may be given as a bitmap pattern. That is, the number of subframes indicated by one bit may be one or more. The period of the pattern is ‘the total length of the bitmap*the number of subframes per bit’, and each bit may be ‘0’ when a subframe directed by the bit is the scheduled subframe and each bit may be ‘1’ when the corresponding subframe is the unscheduled subframe. On the contrary, when each subframe is the scheduled subframe, each bit may be ‘1’ and when each subframe is the unscheduled subframe, each bit may be ‘0’.

For example, it is assumed that the period is ‘20’, a pattern expressing the subframe is ‘1001001000’, the unscheduled subframe is ‘0’, and the number of the subframes indicated by one bit is two. In the pattern representing the subframe, since first, fourth, and seventh bits are ‘1’, subframes #0,#1, #6, #7, #12, and #13 are the scheduled subframes every period.

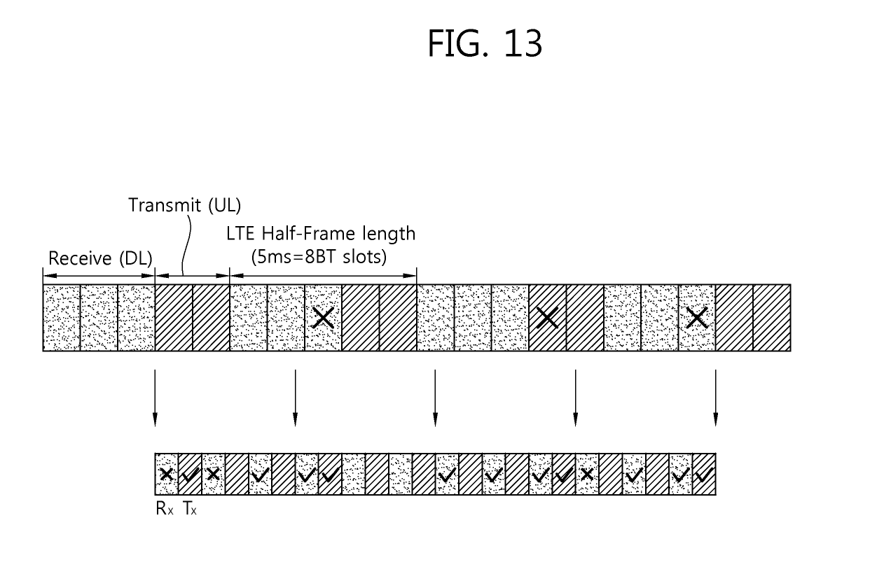

FIG. 13 is a diagram illustrating yet another example of alleviating the in-device coexistence interference according to the present invention.

Referring to FIG. 13, by an autonomously denial scheme, when the in-device coexistence interference occurs in the terminal, transmission of the LTE is denied in order to protect the reception of the ISM. Herein, a ticked part means that transmission or reception is approved and a part marked by ‘X’ means that transmission or reception is denied. As an example, even though UL transmission is granted from the base station, the terminal denies granting not to perform UL transmission in order to protect the reception of the ISM. Similarly, transmission of the ISM is denied in order to protect the reception of the LTE.

Scenarios regarding the on-going IDC state of UE are listed in Table 2 below.

TABLE 2

| SCENARIO | DEFINITION |
|---|---|
| 1 | On-going IDC interference in a serving frequency band |
| 2 | Potential IDC interference existence in a serving frequency |
| | band (not on-going IDC interference) |
| 3 | On-going IDC interference in a frequency band not a |
| | serving frequency band |
| 4 | Potential IDC interference existence in a frequency band |
| | not a serving frequency band (not on-going IDC |
| | interference) |

Each of the scenarios indicates an interference state on the basis of the type of interference and a frequency band. An unusable frequency is not related to whether it is a serving frequency band or not and thus the scenario 1 and the scenario 3 correspond to on-going IDC interference.

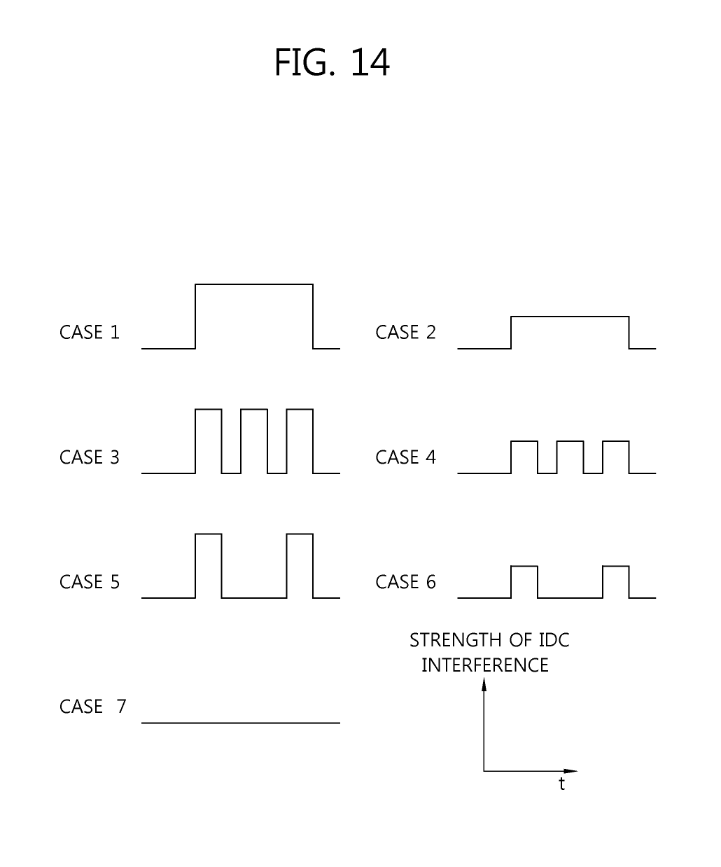

FIG. 14 shows a case where UE receives an interference signal within the device. There are 7 types of cases on the basis of the oftenness and strength (or power) of interference.

Referring to FIG. 14, the 7 types of cases are classified into four patterns as is follows on the basis of the oftenness of interference. The case 1 and the case 2 correspond to continuous patterns, the case 3 and the case 4 correspond to burst patterns, the case 5 and the case 6 correspond to sparse patterns, and the case 7 corresponds to a noise pattern.

The 7 types of cases are classified into three patterns as follows on the basis of the strength of interference. The case 1, the case 3, and the case 5 correspond to too strong patterns, the case 2, the case 4, and the case 6 correspond to enough weak patterns, and the case 7 correspond to a none pattern.

For example, if the IDC interference of UE is determined to be on-going, it may correspond to the case 1 and the case 3. The cases correspond to cases where interference is at least continuous or a burst and correspond to cases where the strength is too strong.

Meanwhile, a state in which IDC interference has occurred, although not corresponding to on-going IDC interference, and the IDC interference has a possibility that it will be changed into an on-going state is defined as ‘potential IDC interference existence’.

For example, UE may determine the case 2, the case 4, the case 5 and the case 6 of FIG. 14 to be potential IDC interference existence. For another example, UE may determine only the case 5 having too strong strength to be potential IDC interference existence. A handover is or RRC configuration/reconfiguration is not impossible in a frequency band including potential IDC interference existence, and UE may perform measurement in the frequency band.

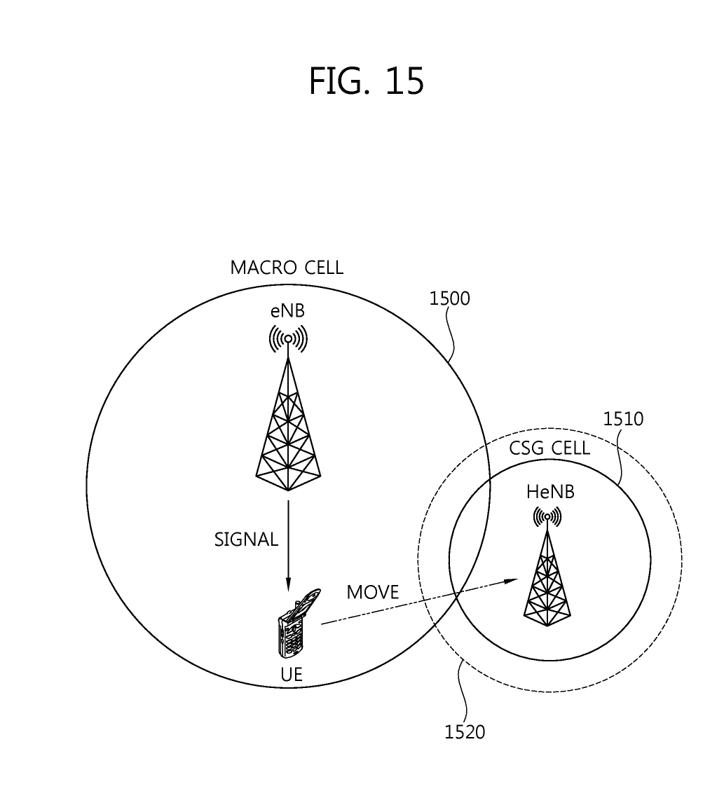

FIG. 15 shows an example of a proximity indication operation which is applied to the present invention. When the approach of UE to the area of a CSG cell (or HeNB) having a Closed Subscriber Group (CSG) ID that belongs to the whitelist of the UE is detected, the UE can send information on the CSG cell (e.g., system information) to a source eNB to and from which the existing signals are being transmitted and received. This procedure is called a proximity indication.

Referring to FIG. 15, when UE that receives a signal from a first eNB, that is, a source eNB, within a macro cell 1500 approaches a second HeNB within a CSG cell 1510, the UE needs to perform a cell change procedure, such as a handover, because it is more preferred that the UE receive a signal from the second HeNB.

In order to perform the cell change procedure more smoothly, the UE performs a proximity indication procedure. For example, when the UE approaches a specific area 1520 near the CSG cell, the UE sends a proximity indication message to the first eNB, that is, the source eNB. Next, the UE performs measurement according to the configuration of the first eNB. If there is no measurement configuration for a frequency belonging to the second HeNB, the UE configures measurement. The UE reports pieces of system information (e.g., a Cell Global ID (CGI), a Tracking Area ID (TAI), and a CSG ID) received from the second HeNB, that is, a target eNB, and system information (e.g., a Physical Cell ID (PCI)), owned by the UE, to the first eNB and performs a cell change procedure, such as a handover from the first eNB to the second HeNB.

Owing to the proximity indication operation, the first eNB does not need to is unnecessarily request pieces of information (e.g., a PCI, a CGI, a TAI, and a CSG ID) in relation to a CSG cell that is not approached.

A method of an eNB requesting or receiving IDC-related information from UE in accordance with the present invention is described below.

Here, a method of controlling IDC interference according to the present invention is described below. Hereinafter, an operation of reducing, avoiding, or removing interference is generally called interference control or interference coordination.

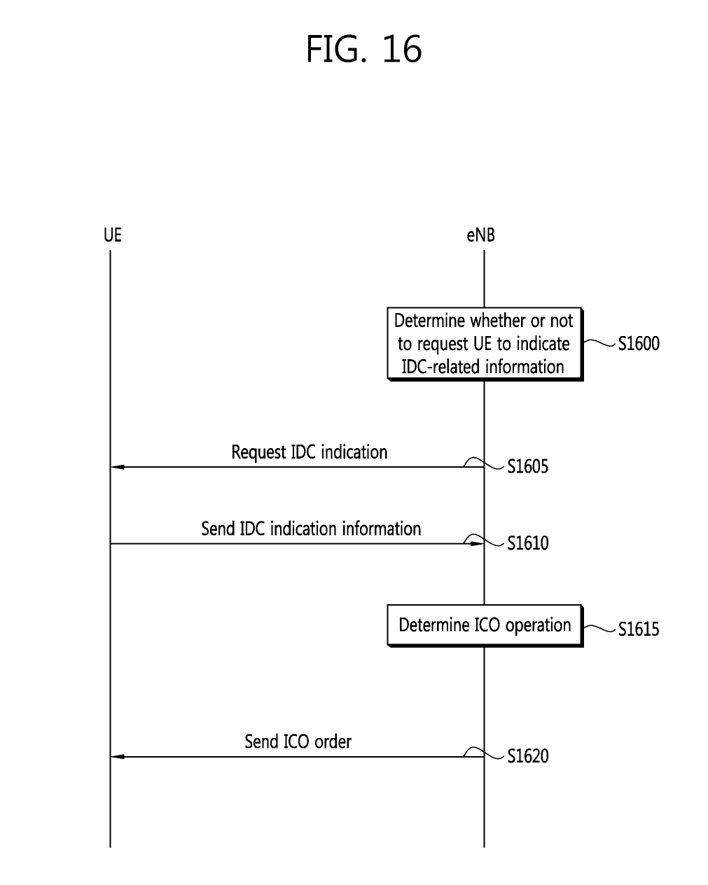

FIG. 16 is a flowchart illustrating an example of the operations of an eNB and UE which performs In-Device Coexistence (IDC) interference control in accordance with the present invention.

Referring to FIG. 16, the eNB determines whether or not to request the UE to indicate information related to IDC situations (hereinafter referred to as an ‘IDC indication’) at step S1600. For example, an eNB may need to receive IDC-related information from UE if it wants to know whether IDC conditions have been changed or not in order to perform load balancing or change scheduling restrictions.

The eNB requests the UE to perform the IDC indication according to the determination at step S1605. An operation of requesting the IDC indication can be performed through Media Access Control (MAC) signaling or Radio Resource Control (RRC) signaling. This is for receiving IDC-related information through the IDC indication.

As an example of the IDC indication request, the eNB may request the IDC indication from the UE in relation to all frequency bands. Here, the on or off of the IDC indication request can be indicated by 1 bit added to a message (e.g., a MAC message or RRC message) that is transmitted from the eNB to the UE. If the 1 bit indicates the ON of the IDC is indication request, the eNB requests the UE to perform an IDC indication operation regarding all the frequency bands.

As another example of the IDC indication request, the eNB may request the IDC indication from the UE in relation to a specific frequency band. A message (e.g., a MAC message or RRC message) including the IDC indication request includes an information element indicative of the specific frequency band.

The specific frequency band may be a frequency band having a possibility that IDC interference exists, that is, a frequency band having a possibility of an unusable frequency. The unusable frequency refers to a frequency through which it is difficult to perform wireless communication because IDC interference is in progress in the corresponding frequency. For example, although there is no IDC interference at the initial access of LTE because the Wi-Fi of UE is not turned on, a band 40 is determined to be a frequency band having a possibility that IDC interference may exist because the band 40 is a frequency band having a possibility of an unusable frequency due to on-going IDC interference in the UE equipped with Wi-Fi. In other words, the specific frequency band may include not only a frequency band including on-going IDC interference, but also a frequency band including potential IDC interference existence.

For another example, the specific frequency band may indicate only a frequency band including on-going IDC interference, that is, an unusable frequency band.

Hereinafter, a frequency band including a possibility that IDC interference may exist may indicate a frequency band including on-going IDC interference or both a frequency band including on-going IDC interference and a frequency band including potential IDC interference existence.

The eNB can indicate a specific frequency band through which the IDC is indication will be requested by using an E-UTRA Absolute Radio Frequency Channel Number (EARFCN). The EARFCN is obtained by splitting the operable frequency band of Evolved-Universal Terrestrial Radio Access (E-UTRA) and assigning a number to the spit frequency band.

For example, a message including the IDC indication request may include all the EARFCN values of frequency bands including a possibility that IDC interference may exist.

For another example, a message including the IDC indication request may include an EARFCN that corresponds to the bound of a frequency band including a possibility that IDC interference may exist. The bound may be an upper bound or a lower bound.

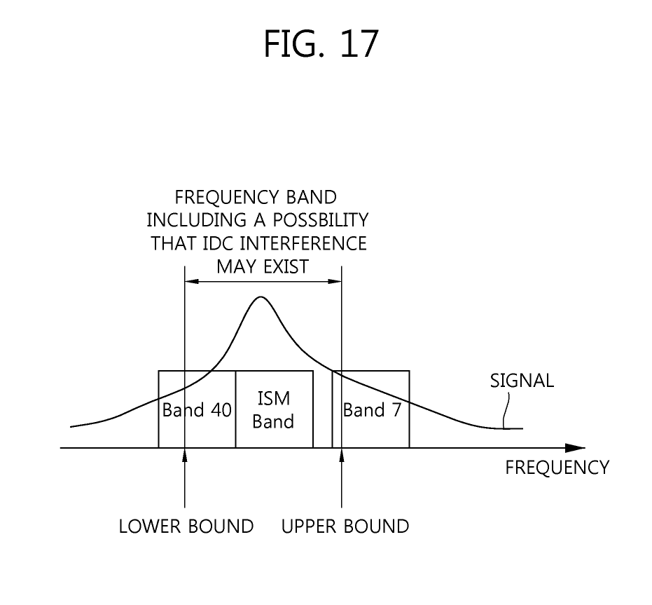

FIG. 17 shows an example in which a frequency band including a possibility that IDC interference may exist is indicated to which the present invention is applied.

Referring to FIG. 17, a frequency band including a possibility that IDC interference may exist is a interval between a lower bound within a band 40 and an upper bound within a band 7.

The message including the IDC indication request may include an EARFCN corresponding to the lower bound, and UE can know that an eNB requests IDC-related information in a frequency band greater than the lower bound based on the EARFCN.

Or, the message including the IDC indication request may include an EARFCN corresponding to the upper bound. UE can know that an eNB requests IDC-related information in a frequency band smaller than the upper bound.

Meanwhile, whether an EARFCN included in the message including the IDC indication request is an upper bound or a lower bound can be previously determined according to the 3^{rd} Generation Partnership Project (3GPP) LTE standard.

Or, an indicator indicating whether an EARFCN is an upper bound or a lower bound may be further included in the message including the IDC indication request. The indicator is called a bound type indicator. UE can determine a frequency band through an IDC indication operation is requested by an eNB on the basis of an EARFCN and the boundary type indicator.

Or, the type of bound may be implicitly determined on the basis of the number of an operating band to which an EARFCN included in the message including the IDC indication request belongs. For example, in FIG. 17, the bound of the band 7 is an upper bound, and the bound of the band 40 is a lower bound. Although there is no bound type indicator as described above, UE may implicitly determine whether an EARFCN corresponds to what bound based on the number of an operating band to which the EARFCN belongs. This is because different EARFCNs may indicate the same frequency band. In an E-UTRA operating band, frequency bands overlap with each other because the band 7 corresponds to 2500-2570 MHz and 2620-2690 MHz, and the band 40 corresponds to 2496-2690 MHz. However, the band 7 and the band 40 have different numbers of operating bands, the band 7 and the band 40 have different EARFCNs, and the band 7 is an FDD scheme and the band 40 is a TDD scheme even in a duplexing method.

For yet another example, the message including the IDC indication request includes an EARFCN, and the EARFCN may be configured so that an eNB requests IDC-related information in relation to the area itself of an operating band where the EARFCN is placed. That is, an operating band unit can be indicated by the EARFCN. For example, if an EARFCN corresponding to the lower bound of FIG. 17 is included in the message including the IDC indication request, UE can know that eNB requests IDC-related information on the band 40 is based on the EARFCN.

For yet another example, if the number of operating bands affected by a frequency band indicated by the EARFCN is plural, the message including the IDC indication request can be configured in such a way as to indicate that an eNB requests IDC-related information in all the operating bands. For example, when a frequency indicated by an EARFCN is 2500 MHz, UE can know that eNB requests IDC-related information in both the band 7 and the band 40 that include 2500 MHz.

For example, the IDC indication request may include information that requests a change of an IDC-related configuration (or setting) on the basis of conditions (or situations, or issues) from a viewpoint of eNB.

For another example, the IDC indication request may include information that requests a response regarding whether a change of an IDC-related configuration (or setting) is permitted (or proper or not so bad) on the basis of conditions (or situations, or issues) from a viewpoint of eNB.

For example, an eNB may send to UE an IDC indication that is recommended by the eNB by using the IDC indication request, and the IDC indication may have the same or similar type or format as or to an IDC indication transmitted by the UE. In response thereto, the UE may send an IDC indication or send information indicative of the denial of the transmission of an IDC indication to the eNB.

After the step S1605, the UE performs an IDC indication operation by sending IDC indication information to the eNB at step S1610. That is, when the UE receives the IDC indication request, the IDC indication operation is triggered.

As an example (embodiment 1) of the IDC indication operation, the UE may perform the IDC indication operation by sending an IDC indication message having a new message format to the eNB. If the IDC indication request of the eNB relates to a specific frequency band, the IDC indication message may be configured so that the IDC indication is performed only in the specific frequency band.

Here, the IDC indication message may include information on an unusable frequency band. For example, the IDC indication message can include all the EARFCN values of frequency bands including a possibility that IDC interference may exist. For another example, the IDC indication message may include an EARFCN corresponding to the bound of a frequency band including a possibility that IDC interference may exist. The bound may be an upper bound or a lower bound. For yet another example, the IDC indication message may include an EARFCN corresponding to the lower bound, and the EARFCN corresponding to the lower bound may be used to indicate that a frequency band greater than the lower bound is an unusable frequency. Or, the IDC indication message may include an EARFCN corresponding to the upper bound, and the EARFCN corresponding to the upper bound may be used to indicate that a frequency band smaller than the upper bound is an unusable frequency. Here, whether an EARFCN included in the IDC indication message is an upper bound or a lower bound may be previously determined according to the 3GPP LTE standard. Or, an indicator (or a boundary type indicator) indicating whether an EARFCN included in the IDC indication message is an upper bound or a lower bound may be further included in the IDC indication message. For yet another example, the type of bound may be implicitly determined on the basis of the number of an operating band to which an EARFCN included in the IDC indication message belongs. For yet another example, the IDC indication message includes an EARFCN, and the EARFCN can indicate that the area itself of an operating band in which the EARFCN is placed is an unusable is frequency band. For yet another example, if the number of operating bands affected by a frequency band indicated by the EARFCN is plural, the IDC indication message can be configured in such a way as to indicate that all the operating bands are unusable frequency bands.

In the case where an IDC entering indicator indicating that an on-going IDC interference state has started is not separately transmitted, if a frequency band that has been recognized as a usable frequency band by an eNB through an IDC indication message is signaled as an unusable frequency band, the eNB may determine that an on-going IDC interference state for the corresponding frequency band has started.

Meanwhile, the IDC indication message may include information on a TDM pattern. The TDM pattern may include at least one among a DRX period, a DRX-active period, and a DRX subframe offset value.

The IDC indication message may further include a measurement result obtained by performing measurement including IDC interference or measurement not including IDC interference depending on a rule that UE obtains measurement samples.

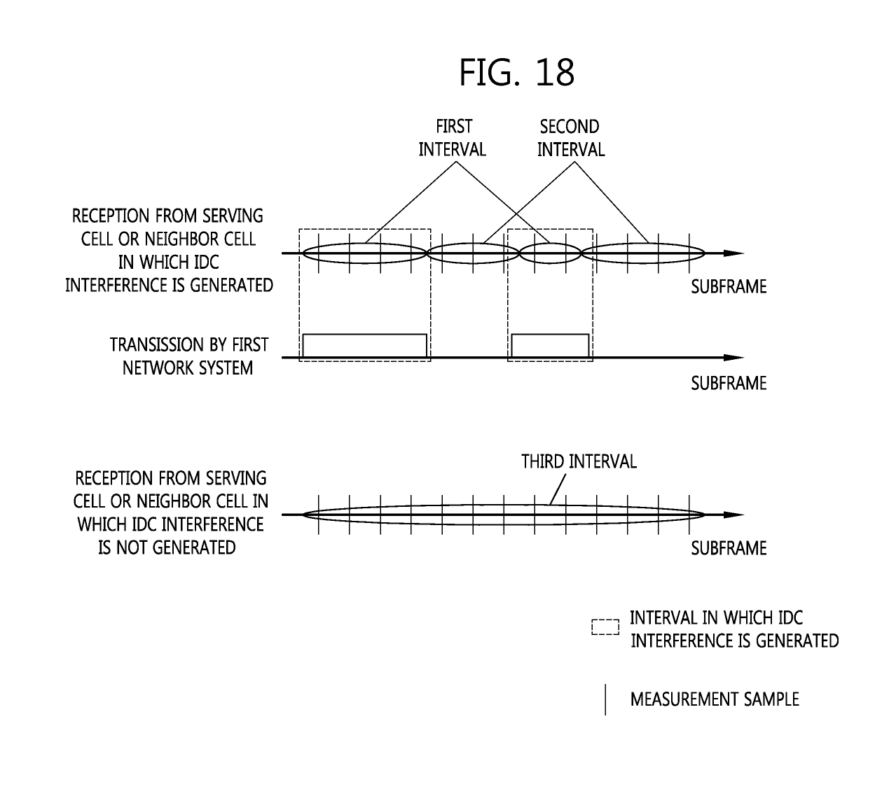

FIG. 18 shows an example in which UE performs measurement including IDC interference or measurement not including IDC interference in accordance with the present invention.

Referring to FIG. 18, the UE obtains measurement samples including the influence of IDC interference in a interval (i.e., a first interval) in which IDC interference in a serving cell or a neighbor cell where IDC interference is generated is generated and obtains measurement samples not including the influence of IDC interference in a interval (i.e., a second interval) in which IDC interference is not generated. Here, the neighbor cell refers to a cell that is has been configured by an RRC connection reestablishment process and used as a comparison group of measurement report events. Furthermore, UE may obtain measurement samples in all intervals (i.e., a third interval) irrespective of IDC interference in a serving cell or a neighbor cell in which IDC interference is not generated. Here, the UE may obtain measurement samples every subframe, in some subframes, or a predetermined subframe in each of the intervals.

For example, a measurement sample including the influence of IDC interference in the first interval may be a measurement sample in which the influence of interference, including all IDC interference, inter-cell interference (e.g., the interference of co-channel serving and non-serving cells and adjacent channel interference) and thermal noise, has been taken into consideration. A measurement sample not including the influence of IDC interference in the second interval may be a measurement sample including only the influence of inter-cell interference or thermal noise.

Here, a first network system refers to a network system that has provided the influence of interference when IDC interference is generated. A network system attached by interference may be called a second network system. For example, when an ISM reception terminal is subject to interference due to LTE uplink, the ISM reception terminal is the second network system. In contrast, when a reception terminal of LTE downlink is subject to interference from an ISM transmission terminal, an LTE system is the second network system.

A measurement sample not including the influence of IDC interference in a neighbor cell, obtained based on RSRQ, may be conceptually represented by Equation 1 below.

MeasurementSample=S/(I+N) [Equation 1]

In Equation 1, ‘S’ is the strength of a received signal through a neighbor cell in a is second network system, ‘I’ is the strength of an interference signal (e.g., inter-cell interference) that acts on the second network system, and ‘N’ is the strength of noise (e.g., thermal noise). That is, a measurement sample means a ratio of the received signal to the interference and the noise.

A measurement sample not including the influence of IDC interference in a neighbor cell, obtained based on RSRP, may be conceptually represented by Equation 2 below.

MeasurementSample=S [Equation 2]

In Equation 2, ‘S’ is the strength of a received signal through a neighbor cell in a second network system. That is, a measurement sample means the strength of the received signal in the neighbor cell in the second network system.

A measurement sample including the influence of IDC interference in a serving cell, obtained based on RSRQ, may be conceptually represented by Equation 3 below.

MeasurementSample=S/(I+N+I′) [Equation 3]

In Equation 3, ‘S’ is the strength of a received signal through a serving cell in a second network system, ‘I’ is the strength of an interference signal (e.g., inter-cell interference) that acts on the second network system, ‘N’ is the strength of noise (e.g., thermal noise), and ‘I′’ is the strength of IDC interference. That is, a measurement sample means a ratio of the received signal to the IDC interference and the inter-cell interference.

A measurement sample including the influence of IDC interference in a serving cell, obtained based on RSRP, may be conceptually represented by Equation 4 below.

MeasurementSample=I′,S+I′,S [Equation 4]

In Equation 4, I′ is the strength of IDC interference and a measurement sample means the strength of an IDC interference signal in a serving cell. ‘S’ is the strength of a received signal in a second network system. If only the influence of IDC interference is sought to be measured, I′ may become a result value. If a value including IDC interference is sought to be measured, S+I′ may become a result value. If a value from which IDC interference has been removed is sought to be measured, S may become a result value.

Meanwhile, an entity (e.g., UE) that performs the measurement may be one or plural. For example, an entity that performs measurement including IDC interference and an entity that performs measurement not including IDC interference may exist independently.

Here, a measurement result means a value that has been finally calculated by filtering measurement samples. For example, in the case of LTE, the final Reference Signal Received Power (RSRP) and Reference Signal Received Quality (RSRQ) values generated through L1 filtering and L3 filtering are measurement results reported to an eNB. A result of measurement including IDC interference may be a result obtained by filtering only measurement samples including IDC interference or a result obtained by filtering both measurement samples including IDC interference and measurement samples not including IDC interference. Furthermore, a result of measurement from which IDC interference has been removed may be a result obtained by filtering only measurement samples not including IDC interference or may be a result obtained by filtering both measurement samples not including IDC interference and measurement samples from which IDC interference has been removed by an interference removal scheme.

For example, a measurement result included in an IDC indication message may is be a measurement result from which IDC interference has been removed. For another example, a measurement result included in an IDC indication message may be a measurement result in which IDC interference has been taken into consideration. For yet another example, a measurement result included in an IDC indication message may include both a measurement result from which IDC interference has been removed and a measurement result in which IDC interference has been taken into consideration. For yet another example, a measurement result included in an IDC indication message may include both the intensity of IDC interference and a measurement result from which IDC interference has been removed. For yet another example, a measurement result included in an IDC indication message may include both the intensity of IDC interference and a measurement result in which IDC interference has been taken into consideration. For yet another example, a measurement result included in an IDC indication message may include all of the intensity of IDC interference, the activity of IDC interference, and a measurement result from which IDC interference has been removed. Here, the activity of IDC interference means an index indicating that how often is IDC interference generated in terms of the time. For example, the activity of IDC interference may be defined by a ratio of subframes where IDC interference is not generated and subframes where IDC interference is generated. As an example of a possible implementation, there may be a scheme for calculating the mean value based on a weight every subframe. For another example, a measurement result included in an IDC indication message may include all of the intensity of IDC interference, the activity of IDC interference, and a measurement result in which IDC interference has been taken into consideration.

As another example (embodiment 2) of the IDC indication operation at step S1610, the UE may perform the IDC indication operation by sending a measurement report is message to the eNB. If the IDC indication request of the eNB relates to a specific frequency band, the measurement report message may be configured so that an IDC indication is performed on only the specific frequency band. The measurement report message may include not only a measurement result, but also information on an unusable frequency or information on a TDM pattern.

For example, the measurement report message may include all the EARFCN values of frequency bands including a possibility that IDC interference may exist. For another example, the measurement report message may include an EARFCN corresponding to the bound of a frequency band including a possibility that IDC interference may exist. The bound may be an upper bound or a lower bound. For yet another example, the measurement report message may include an EARFCN corresponding to the lower bound, and the EARFCN corresponding to the lower bound may be used to indicate that a frequency band greater than the lower bound is an unusable frequency. Or, the measurement report message may include an EARFCN corresponding to the upper bound, and the EARFCN corresponding to the upper bound may be used to indicate that a frequency band smaller than the upper bound is an unusable frequency. Here, whether an EARFCN included in the measurement report message is an upper bound or a lower bound may be previously determined according to the 3GPP LTE standard. Or, an indicator (or a boundary type indicator) indicating whether an EARFCN included in the measurement report message is an upper bound or a lower bound may be further included in the measurement report message. For yet another example, the type of bound may be implicitly determined on the basis of the number of an operating band to which an EARFCN included in the measurement report message belongs. For yet another example, the measurement report message includes an EARFCN, and the EARFCN may indicate that the area itself of an is operating band in which the EARFCN is placed is an unusable frequency band. For yet another example, if the number of operating bands affected by a frequency band indicated by the EARFCN is plural, the measurement report message may be configured in such a way as to indicate that all the operating bands are unusable frequency bands.

In the case where an IDC entering indicator indicating that an on-going IDC interference state has started is not separately transmitted, if a frequency band that has been recognized as a usable frequency band by an eNB through an measurement report message is signaled as an unusable frequency band, the eNB may determine that an on-going IDC interference state for the corresponding frequency band has started.

Meanwhile, the measurement report message may include information on a TDM pattern. The TDM pattern may include at least one among a DRX period, a DRX-active period, and a DRX subframe offset value.

The number of pieces of the information on an unusable frequency or the information on a TDM pattern included in the measurement report message may be one or plural. If the number of pieces of the information on an unusable frequency or the information on a TDM pattern is plural, the information on an unusable frequency and the information on a TDM pattern are paired and signaled.

Furthermore, the measurement report message may include a measurement result obtained by performing measurement according to a rule that UE obtains measurement samples. Here, the UE may perform measurement including IDC interference or measurement from which IDC interference has been removed. For example, a measurement result included in the measurement report message may be a measurement result from which IDC interference has been removed. For another example, a measurement result included in the measurement report is message may be a measurement result in which IDC interference has been taken into consideration. For yet another example, a measurement result included in the measurement report message may include both a measurement result from which IDC interference has been removed and a measurement result in which IDC interference has been taken into consideration. For yet another example, a measurement result included in the measurement report message may include both the intensity of IDC interference and a measurement result from which IDC interference has been removed. For yet another example, a measurement result included in the measurement report message may include both the intensity of IDC interference and a measurement result in which IDC interference has been taken into consideration. For yet another example, a measurement result included in the measurement report message may include all of the intensity of IDC interference, the activity of IDC interference, and a measurement result from which IDC interference has been removed. For yet another example, a measurement result included in the measurement report message may include all of the intensity of IDC interference, the activity of IDC interference, and a measurement result in which IDC interference has been taken into consideration.

As yet another example (embodiment 3) of the IDC indication operation at the step S1610, the UE may perform the IDC indication operation by sending a proximity indication message used in a proximity indication operation to the eNB. If the IDC indication request of the eNB relates to a specific frequency band, the proximity indication message may be configured so that the IDC indication operation is performed only on the specific frequency band.

An identifier for distinguishing a proximity indication message for the existing CSG and a proximity indication message for IDC indication information from each other may be is further included in the proximity indication message.

When the IDC indication information is included in the proximity indication message, the proximity indication message includes information on an unusable frequency or a TDM pattern. Or, the proximity indication message may further include a measurement result included in a measurement report message.

As an example in which the proximity indication message includes information on an unusable frequency, the proximity indication message may include all the EARFCN values of frequency bands including a possibility that IDC interference may exist. For another example, the proximity indication message may include an EARFCN corresponding to the bound of a frequency band including a possibility that IDC interference may exist. The bound may be an upper bound or a lower bound. For yet another example, the proximity indication message may include an EARFCN corresponding to the lower bound, and the EARFCN corresponding to the lower bound may be used to indicate that a frequency band greater than the lower bound is an unusable frequency. Or, the proximity indication message may include an EARFCN corresponding to the upper bound, and the EARFCN corresponding to the upper bound may be used to indicate that a frequency band smaller than the upper bound is an unusable frequency. Here, whether an EARFCN included in the proximity indication message is an upper bound or a lower bound may be previously determined according to the 3GPP LTE standard. Or, an indicator (or a boundary type indicator) indicating whether an EARFCN included in the proximity indication message is an upper bound or a lower bound may be further included in the proximity indication message. For yet another example, the type of bound may be implicitly determined on the basis of the number of an operating band to which an EARFCN included in the proximity indication message belongs. For yet another example, the proximity indication is message includes an EARFCN, and the EARFCN may indicate that the area itself of an operating band in which the EARFCN is placed is an unusable frequency band. For yet another example, if the number of operating bands affected by a frequency band indicated by the EARFCN is plural, the proximity indication message may be configured in such a way as to indicate that all the operating bands are unusable frequency bands.

In the case where an IDC entering indicator indicating that an on-going IDC interference state has started is not separately transmitted, if a frequency band that has been recognized as a usable frequency band by an eNB through an proximity indication message is signaled as an unusable frequency band, the eNB may determine that an on-going IDC interference state for the corresponding frequency band has started.

Meanwhile, the proximity indication message may include information on a TDM pattern. The TDM pattern may include at least one among a DRX period, a DRX-active period, and a DRX subframe offset value.

The number of pieces of the information on an unusable frequency or the information on a TDM pattern included in the proximity indication message may be one or plural. If the number of pieces of the information on an unusable frequency or the information on a TDM pattern included in the proximity indication message is plural, the information on an unusable frequency and the information on a TDM pattern are paired and signaled.

For example, an eNB may send to UE an IDC indication that is recommended by the eNB by using the IDC indication request. In response thereto, the UE may send an IDC indication or send information indicative of the denial of the transmission of an IDC indication to the eNB.

After the step S1610, the eNB determines the most appropriate In-device is Coexistence interference Coordination (hereinafter referred to as ‘ICO’) operation based on the IDC indication information received from the UE at step S1615. Here, the ICO operation may be an FDM operation or a TDM operation. The FDM operation or the TDM operation may be an operation according to FIGS. 5 to 13. For example, when the eNB has a problem in a frequency band through which service is provided, the FDM operation is performed if a usable frequency band does not have a problem due to load balancing and also does not have a great influence on a handover based on IDC indication information (e.g., if the RSRP or RSRQ value of the usable frequency band is sufficient high) and the TDM operation may be performed in the serving cell if not.

The eNB sends an ICO order to the UE at step S1620. For example, the ICO order may be transmitted through an RRC connection reestablishment message.

For example, the ICO operation may include the operation of a prohibition timer that prohibits the transmission of an IDC indication message (or a measurement report message or a proximity indication message) for a specific time. Even in this case, the IDC indication operation according to the IDC indication request of the eNB may be permitted.

For another example, if the determined ICO operation is the FDM operation, a secondary serving cell may be changed through a serving cell management operation (e.g., deletes a problematic secondary serving cell). Or, a handover procedure for changing a primary serving cell may be initiated.

For yet another example, if the determined ICO operation is the TDM operation, a specific DRX pattern may be transmitted through an RRC connection reestablishment message.

For yet another example, if the determined ICO operation is the TDM operation, an indicator, indicating that a specific DRX pattern is for IDC, along with the specific DRX pattern, may be transmitted through an RRC connection reestablishment message.

Measurement performed by the UE may be changed differently from previous measurement depending on the indication of the indicator.

For yet another example, if the determined ICO operation is the TDM operation, the retransmission of an HARQ in an LTE band may be denied for the handling of a beacon when a signal is transmitted in the ISM band. That is, the start of the ICO operation may be ordered through an IDC indication message (or a measurement report message or a proximity indication message).

Meanwhile, if the ICO operation determined by the eNB based on the IDC indication information is identical with the existing ICO operation that is already being performed, the ICO ordering process may be omitted.

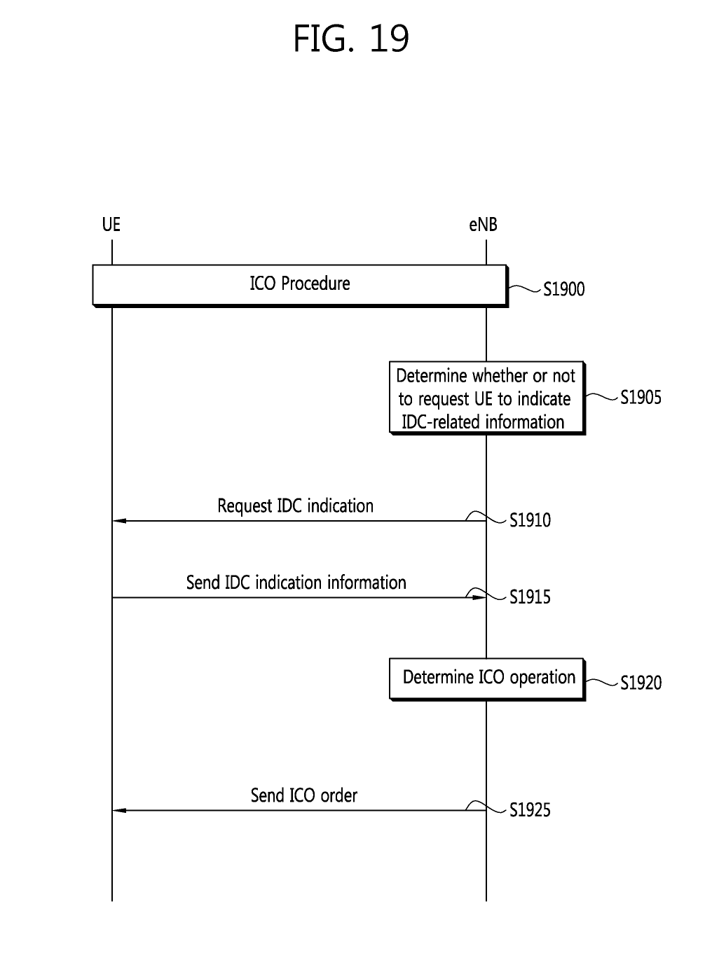

FIG. 19 is a flowchart illustrating another example of the operations of an eNB and UE for performing ICO in accordance with the present invention.

Referring to FIG. 19, an ICO procedure is performed between the eNB and the UE at step S1900.

In the ICO procedure, IDC triggering for triggering an event indicating that an on-going IDC interference state has started or ended includes two types. First, there is a type (i.e., a first type) in which UE performs IDC triggering based on a threshold set by an eNB. Second, there is a type (i.e., a second type) in which UE fully performs IDC triggering according to an implementation criterion within the UE.

From among the two types, in the second type, that is, if UE fully performs IDC triggering according to an implementation criterion within the UE, there may be a misalignment problem because a point of time at which the UE actually performs triggering is not matched with a point of time at which an eNB will perform an IDC-related operation.

This may lead to a severe problem in performing a load balancing function. In particular, when performing an FDM operation, a problem related to the mobility of UE may occur.

If a point of time at which IDC triggering by which an ICO procedure is performed is performed is different from a point of time at which load balancing is applied as described above, the eNB may determine to request the UE to indicate information related to IDC conditions at step S1905. The eNB may check whether IDC conditions are valid or not even at a different point of time or check whether there are changed conditions or not.

If the eNB does not request the IDC indication from the UE, the UE may operate. In this case, however, there is a high possibility that the operation may be instable.

According to the determination, the eNB requests the UE to perform an IDC indication at step S1910. An operation of requesting the IDC indication may be performed through MAC signaling or RRC signaling.

As an example of the IDC indication request, the eNB may request the UE to perform the IDC indication for all frequency bands. Here, the on or off of the IDC indication request may be indicated by 1 bit that is added to a message (e.g., a MAC message or an RRC message) transmitted from the eNB to the UE. When the 1 bit indicates the ON of the IDC indication request, the eNB requests the UE to perform the IDC indication operation for all frequency bands.

As another example of the IDC indication request, the eNB may request the UE to perform the IDC indication for a specific frequency band. A message (e.g., a MAC message or an RRC message) including the IDC indication request includes an information element is indicative of the specific frequency band. The specific frequency band may be a frequency band including a possibility that IDC interference may exist, that is, a frequency band having a possibility of an unusable frequency. The frequency band including a possibility that IDC interference may exist may be a frequency band including on-going IDC interference or both a frequency band including on-going IDC interference and a frequency band including potential IDC interference existence.

The eNB may indicate the specific frequency band for requesting the IDC indication by using an EARFCN or an operating band.

After the step S1910, the UE performs the IDC indication operation by sending IDC indication information to the eNB at step S1915. When the UE receives the IDC indication request from the eNB, the IDC indication operation is triggered.

As an example of the IDC indication operation at the step S1915, the UE may perform the IDC indication operation by sending an IDC indication message having a new message format to the eNB. If the IDC indication request of the eNB relates to a specific frequency band, the IDC indication message may be configured so that the IDC indication operation is performed only on the specific frequency band.

Here, the IDC indication message may include information on an unusable frequency band. The IDC indication message may further include information on a TDM pattern. The TDM pattern may be a DRX period, a DRX-active period, or a DRX subframe offset value. The IDC indication message may further include a measurement result of measurement including IDC interference or measurement not including IDC interference depending on a rule that the UE obtains measurement samples.

As another example of the IDC indication operation at the step S1915, the UE is may perform the IDC indication operation by sending a measurement report message to the eNB. If the IDC indication request of the eNB relates to a specific frequency band, the measurement report message may also be configured so that the IDC indication operation is performed only on the specific frequency band.

The measurement report message may include not only a measurement result, but also information on an unusable frequency or information on a TDM pattern. The number of pieces of the information on an unusable frequency or the information on a TDM pattern included in the measurement report message may be one or plural. If the number of pieces of the information on an unusable frequency or the information on a TDM pattern is plural, the information on an unusable frequency and the information on a TDM pattern are paired and signaled.

As yet another example of the IDC indication operation at the step S1915, the UE may perform the IDC indication operation by sending a proximity indication message, used in a proximity indication operation, to the eNB. If the IDC indication request of the eNB relates to a specific frequency band, the proximity indication message may also be configured so that the IDC indication operation is performed only on the specific frequency band.

Here, an identifier for distinguishing a proximity indication message for the existing CSG from the proximity indication message including the IDC indication information may be further included in the proximity indication message.

When the IDC indication information is included in the proximity indication message, the proximity indication message may include information on an unusable frequency or information on a TDM pattern. The number of pieces of the information on an unusable frequency or the information on a TDM pattern included in the proximity indication message is may be one or plural. If the number of pieces of the information on an unusable frequency or the information on a TDM pattern is plural, the information on an unusable frequency and the information on a TDM pattern are paired and signaled.

After the step S1915, the eNB determines the most appropriate ICO operation based on the IDC indication information received from the UE at step S1920. Here, the ICO operation may be an FDM operation or a TDM operation. The FDM operation or the TDM operation may be an operation according to FIGS. 5 to 13.

The eNB sends an ICO order to the UE at step S1925. For example, the ICO order may be transmitted through an RRC connection reestablishment message.

The ICO operation may include the operation of a prohibition timer for prohibiting the transmission of an IDC indication message (or a measurement report message or a proximity indication message) for a specific time. Even in this case, the IDC indication operation according to the IDC indication request of the eNB may be permitted.

Meanwhile, if the ICO operation determined by the eNB based on the IDC indication information is identical with the existing ICO operation that is already being performed, the ICO ordering process may be omitted.

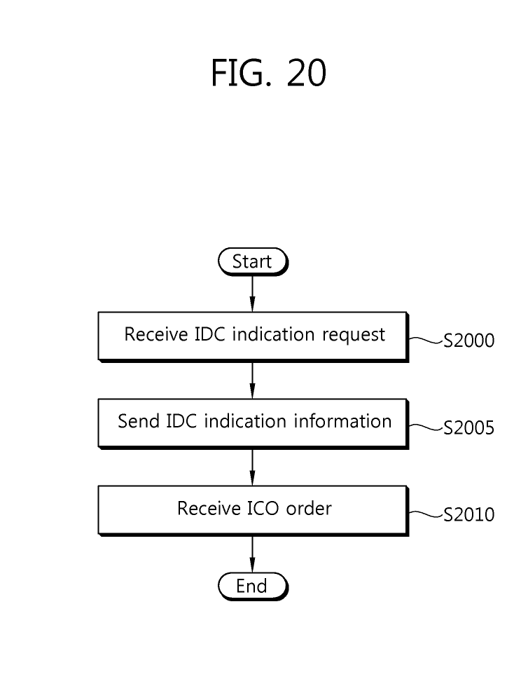

FIG. 20 is a flowchart illustrating an example of the operation of UE for performing ICO in accordance with the present invention.

Referring to FIG. 20, the UE receives an IDC indication request from an eNB at step S2000. For example, in the case where IDC triggering is fully performed by an implementation criterion within the UE when an ICO procedure is performed between the eNB and the UE, if a point of time at which triggering is actually performed by the UE is not identical with a point of time at which an IDC-related operation will be performed by the eNB, it may lead is to a severe problem in performing a load balancing function. In this case, the eNB may determine to request the UE to indicate information related to IDC conditions and thus check whether the IDC conditions are valid or not even in a different point of time. An operation of the UE receiving the IDC indication request from the eNB may be performed through MAC signaling or RRC signaling.

As an example of the IDC indication request, the eNB may request the UE to perform the IDC indication for all frequency bands. Here, the UE may determine the on or off of the IDC indication request through 1 bit added to a message (e.g., a MAC message or an RRC message) received from the eNB. When the 1 bit indicates the ON of the IDC indication request, it means that the eNB requests the UE to perform the IDC indication operation for all frequency bands.

As another example of the IDC indication request, the eNB may request the UE to perform the IDC indication for a specific frequency band. A message (e.g., a MAC message or an RRC message) including the IDC indication request includes an information element indicative of the specific frequency band. The specific frequency band may be a frequency band including a possibility that IDC interference may exist, that is, a frequency band having a possibility of an unusable frequency. The frequency band including a possibility that IDC interference may exist may be a frequency band including on-going IDC interference or both a frequency band including on-going IDC interference and a frequency band including potential IDC interference existence.

The UE may determine a specific frequency band through which the IDC indication will be requested through an EARFCN or operating band.

After the step S2000, the UE performs an IDC indication operation by sending IDC indication information to the eNB at step S2005. When the UE receives the IDC indication request, the IDC indication operation is triggered.

As an example of the IDC indication operation at the step S2005, the UE may perform the IDC indication operation by sending an IDC indication message having a new message format to the eNB. If the IDC indication request of the eNB relates to a specific frequency band, the IDC indication message may also be configured so that the IDC indication operation is performed only on the specific frequency band.

Here, the IDC indication message may include information on an unusable frequency band. The IDC indication message may further include information on a TDM pattern. The TDM pattern may be a DRX period, a DRX-active period, or a DRX subframe offset value. The IDC indication message may further include a measurement result of measurement including IDC interference or measurement not including IDC interference depending on a rule that the UE obtains measurement samples.

As another example of the IDC indication operation at the step S2005, the UE may perform the IDC indication operation by sending a measurement report message to the eNB. If the IDC indication request of the eNB relates to a specific frequency band, the measurement report message may also be configured so that the IDC indication operation is performed only on the specific frequency band.

The measurement report message may include not only a measurement result, but also information on an unusable frequency or information on a TDM pattern. The number of pieces of the information on an unusable frequency or the information on a TDM pattern included in the measurement report message may be one or plural. If the number of pieces of the information on an unusable frequency or the information on a TDM pattern is plural, the is information on an unusable frequency and the information on a TDM pattern are paired and signaled.

As yet another example of the IDC indication operation at the step S2005, the UE may perform the IDC indication operation by sending a proximity indication message, used in a proximity indication operation, to the eNB. If the IDC indication request of the eNB relates to a specific frequency band, the proximity indication message may also be configured so that the IDC indication operation is performed only on the specific frequency band.

Here, an identifier for distinguishing a proximity indication message for the existing CSG from the proximity indication message including the IDC indication information may be further included in the proximity indication message.

When the IDC indication information is included in the proximity indication message, the proximity indication message may include information on an unusable frequency or information on a TDM pattern. The number of pieces of the information on an unusable frequency or the information on a TDM pattern included in the proximity indication message may be one or plural. If the number of pieces of the information on an unusable frequency or the information on a TDM pattern is plural, the information on an unusable frequency and the information on a TDM pattern are paired and signaled.

After the step S2005, the UE receives an ICO order determined by the eNB at step S2010. For example, the ICO order may be received through an RRC connection reestablishment message. The eNB determines the most appropriate ICO operation based on the IDC indication information received from the UE. The ICO operation may be an FDM operation or a TDM operation, and the FDM operation or the TDM operation may be an operation according to FIGS. 5 to 13.

The ICO operation may include the operation of a prohibition timer for prohibiting the transmission of an IDC indication message (or a measurement report message or a proximity indication message) for a specific time. Even in this case, the IDC indication operation according to the IDC indication request of the eNB may be permitted.

Meanwhile, if the ICO operation determined by the eNB based on the IDC indication information is identical with the existing ICO operation that is already being performed, the ICO ordering process may be omitted. Accordingly, if the UE does not receive an ICO order for a specific time, the existing order may indicate that the on-going ICO operation continues to be performed.

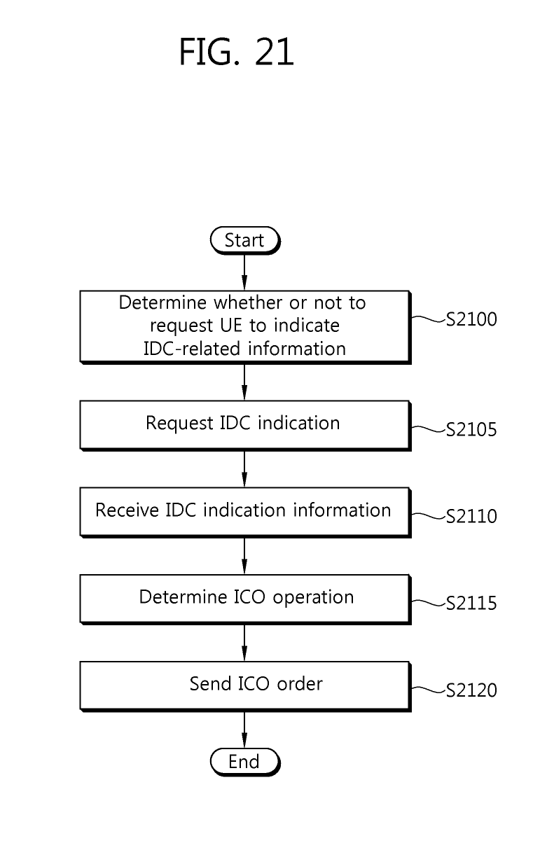

FIG. 21 is a flowchart illustrating an example of the operation of an eNB for performing ICO in accordance with the present invention.

Referring to FIG. 21, the eNB determines to request UE to indicate information related to IDC conditions at step S2100. For example, in the case where IDC triggering is fully performed by an implementation criterion within the UE, if a point of time at which IDC triggering by which an ICO procedure is performed is performed is different from a point of time at which load balancing is applied, the IDC indication is requested in order to check whether the IDC conditions are valid or not even at a different point of time.

According to the determination of the eNB, the eNB requests the UE to perform the IDC indication at step S2105. An operation of requesting the IDC indication may be performed through MAC signaling or RRC signaling.

As an example of the IDC indication request, the eNB may request the UE to perform the IDC indication for all frequency bands. Here, the eNB may indicate the on or off of the IDC indication request by using 1 bit added to a message (e.g., a MAC message or an RRC is message) received from the eNB. When the 1 bit indicates the ON of the IDC indication request, the eNB requests the UE to perform the IDC indication operation for all frequency bands.

As another example of the IDC indication request, the eNB may request the UE to perform the IDC indication for a specific frequency band. A message (e.g., a MAC message or an RRC message) including the IDC indication request includes an information element indicative of the specific frequency band. The specific frequency band may be a frequency band including a possibility that IDC interference may exist, that is, a frequency band having a possibility of an unusable frequency. The frequency band including a possibility that IDC interference may exist may be a frequency band including on-going IDC interference or both a frequency band including on-going IDC interference and a frequency band including potential IDC interference existence.

The eNB may indicate a specific frequency band through which the IDC indication will be requested by using an EARFCN or an operating band.

After the step S2105, the eNB receives IDC indication information from the UE at step S2110. Next, an UE performs an IDC indication operation.

As an example of the IDC indication operation, the eNB may receive the IDC indication information from the UE through an IDC indication message having a new message format. If the IDC indication request of the eNB relates to a specific frequency band, the IDC indication message may also be configured so that the IDC indication operation is performed only on the specific frequency band.

Here, the IDC indication message may include information on an unusable frequency band. The IDC indication message may further include information on a TDM pattern. The TDM pattern may be a DRX period, a DRX-active period, or a DRX subframe offset value. The IDC indication message may further include a measurement result of measurement including IDC interference or measurement not including IDC interference depending on a rule that the UE obtains measurement samples.

As another example of the IDC indication operation, the eNB may receive the IDC indication information from the UE through a measurement report message. If the IDC indication request of the eNB relates to a specific frequency band, the measurement report message may also be configured so that the IDC indication operation is performed only on the specific frequency band.

The measurement report message may include not only a measurement result, but also information on an unusable frequency or information on a TDM pattern. The number of pieces of the information on an unusable frequency or the information on a TDM pattern included in the measurement report message may be one or plural. If the number of pieces of the information on an unusable frequency or the information on a TDM pattern is plural, the information on an unusable frequency and the information on a TDM pattern are paired and signaled.

As yet another example of the IDC indication operation, the eNB may receive the IDC indication information from the UE through a proximity indication message used in a proximity indication operation. If the IDC indication request of the eNB relates to a specific frequency band, the proximity indication message may also be configured so that the IDC indication operation is performed only on the specific frequency band.

Here, an identifier for distinguishing a proximity indication message for the existing CSG from the proximity indication message including the IDC indication information is may be further included in the proximity indication message.

When the IDC indication information is included in the proximity indication message, the proximity indication message may include information on an unusable frequency or information on a TDM pattern. The number of pieces of the information on an unusable frequency or the information on a TDM pattern included in the proximity indication message may be one or plural. If the number of pieces of the information on an unusable frequency or the information on a TDM pattern is plural, the information on an unusable frequency and the information on a TDM pattern are paired and signaled.

After the step S2110, the eNB determines the most appropriate ICO operation based on the IDC indication information received from the UE at step S2115. Here, the ICO operation may be an FDM operation or a TDM operation. The FDM operation or the TDM operation may be an operation according to FIGS. 5 to 13.

The eNB sends an ICO order to the UE at step S2120. For example, the ICO order may be transmitted through an RRC connection reestablishment message.

In response to the ICO order, the UE may perform an ICO operation, that is, transmit an IDC indication message (or a measurement report message or a proximity indication message).

In accordance with the present invention, UE may use a prohibition timer in order to prevent the frequent transmission of interference information due to changing IDC interference. After UE has detected the generation of IDC interference and transferred interference information, the UE does not transfer interference information to an eNB again although IDC interference is detected during the time when the prohibition timer is driving. In this case, the frequent transfer of interference information by UE due to the generation of IDC interference may be prevented, and thus the consumption of uplink transmission resources by an eNB due to the frequent transmission of the interference information may be prevented.

To this end, in the present invention, UE may stop (or inhibit) an IDC indication operation, that is, the transmission of an IDC indication message (or a measurement report message or a proximity indication message), for a specific time by using a prohibition timer. If there is an IDC indication request from an eNB, however, an IDC indication operation may be performed although the prohibition timer is driven. That is, the UE may report an IDC indication message to the eNB during the time when the prohibition timer is driving.

As another operation, although there is an IDC indication request from an eNB, UE may stop (or inhibit) an IDC indication operation, that is, the transmission of an IDC indication message (or a measurement report message or a proximity indication message) by assigning priority to the operation of a prohibition timer.

Meanwhile, if an ICO operation determined by an eNB based on IDC indication information is identical with an ICO operation that is already performed, an ICO ordering process may be omitted.

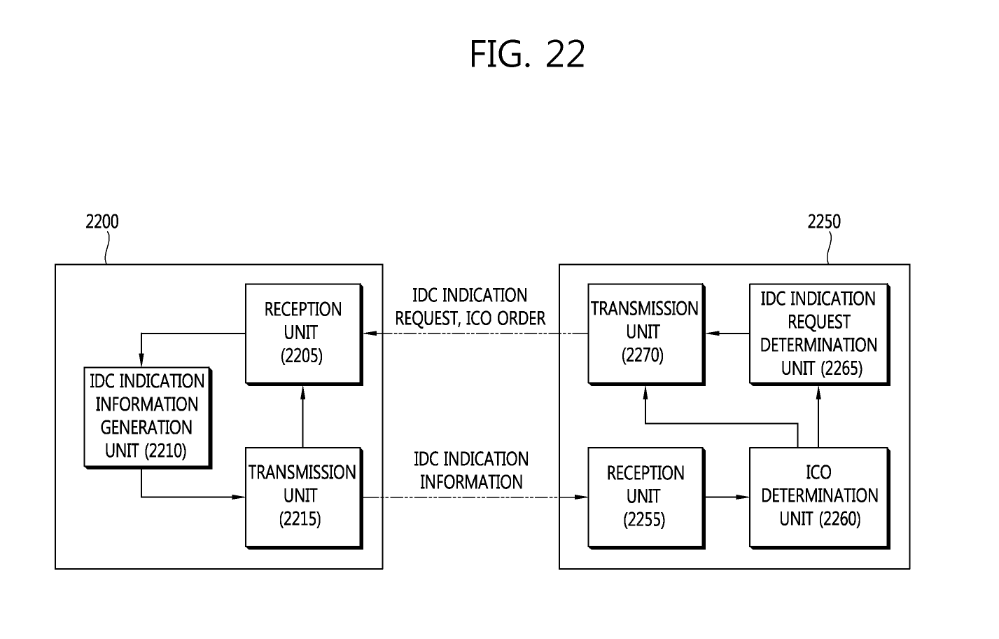

FIG. 22 is a block diagram of an apparatus for transmitting and receiving information on IDC interference in accordance with an example of the present invention.

Referring to FIG. 22, UE 2200 and an eNB 2250 exchanges pieces of information on IDC interference.

The UE 2200 includes a reception unit 2205, an IDC indication information generation unit 2210, and a transmission unit 2215.

The reception unit 2205 receives an IDC indication request from the eNB 2250. For example, in the case where IDC triggering is fully performed by an implementation criterion is within the UE when an ICO procedure is performed between the eNB and the UE, if a point of time at which triggering is actually performed by the UE is not identical with a point of time at which an IDC-related operation will be performed by the eNB, it may lead to a severe problem in performing a load balancing function. In this case, the eNB may determine to request the UE to indicate information related to IDC conditions and thus check whether the IDC conditions are valid or not even in a different point of time. An operation of the UE receiving the IDC indication request from the eNB may be performed through MAC signaling or RRC signaling. For example, the eNB may request the UE to perform the IDC indication for all frequency bands. Here, the UE may determine the on or off of the IDC indication request based on 1 bit added to a message (e.g., a MAC message or an RRC message) received from the eNB. For another example, the eNB may request the UE to perform the IDC indication for a specific frequency band. A message (e.g., a MAC message or an RRC message) including the IDC indication request includes an information element indicative of the specific frequency band. The specific frequency band may be a frequency band including a possibility that IDC interference may exist, that is, a frequency band having a possibility of an unusable frequency. The frequency band including a possibility that IDC interference may exist may be a frequency band including on-going IDC interference or both a frequency band including on-going IDC interference and a frequency band including potential IDC interference existence. The UE 2200 may determine a specific frequency band through which the IDC indication will be requested through an EARFCN or operating band.

The reception unit 2205 receives an ICO order, determined by the eNB 2250, from the eNB 2250. For example, the ICO order may be received through an RRC connection reestablishment message. The eNB 2250 determines the most appropriate ICO operation based is on IDC indication information. The ICO operation may be an FDM operation or a TDM operation, and the FDM operation or the TDM operation may be an operation according to FIGS. 5 to 13. The ICO operation may include the operation of a prohibition timer for prohibiting the transmission of an IDC indication message (or a measurement report message or a proximity indication message) for a specific time. Even in this case, an IDC indication operation according to the IDC indication request of the eNB 2250 may be permitted. Meanwhile, if the ICO operation determined by the eNB based on IDC indication information is identical with the existing ICO operation that is already being performed, the ICO ordering process may be omitted. Accordingly, if the UE does not receive an ICO order for a specific time, the existing order may indicate that the on-going ICO operation continues to be performed.

The IDC indication information generation unit 2210 generates IDC indication information to be transmitted to the eNB 2250. The IDC indication information may include information on an unusable frequency band, information on a TDM pattern, or a measurement result.

The transmission unit 2215 transmits the IDC indication information to the eNB 2250.

For example, the transmission unit 2215 may send the IDC indication information to the eNB 2250 through an IDC indication message having a new message format. If the IDC indication request of the eNB relates to a specific frequency band, the IDC indication message may also be configured so that the IDC indication is performed only on the specific frequency band. Here, the IDC indication message may include information on an unusable frequency band. The IDC indication message may further include information on a TDM pattern. The TDM pattern may be a DRX period, a DRX-active period, or a DRX subframe offset value. The IDC indication message may further include a measurement result of measurement including IDC interference or measurement not including IDC interference depending on a rule that the UE obtains measurement samples.

For another example, the transmission unit 2215 may send the IDC indication information to the eNB 2250 through a measurement report message.

If the IDC indication request of the eNB relates to a specific frequency band, the measurement report message may also be configured so that the IDC indication is performed only on the specific frequency band. The measurement report message may include not only a measurement result, but also information on an unusable frequency or information on a TDM pattern. The number of pieces of the information on an unusable frequency or the information on a TDM pattern included in the measurement report message may be one or plural. If the number of pieces of the information on an unusable frequency or the information on a TDM pattern is plural, the information on an unusable frequency and the information on a TDM pattern are paired and signaled.

For yet another example, the transmission unit 2215 may send the IDC indication information to the eNB 2250 through a proximity indication message used in a proximity indication operation. If the IDC indication request of an eNB relates to a specific frequency band, the proximity indication message may also be configured so that the IDC indication operation is performed only on the specific frequency band. Here, an identifier for distinguishing a proximity indication message for the existing CSG from the proximity indication message including the IDC indication information may be further included in the proximity indication message. When the IDC indication information is included in the proximity indication message, the proximity indication message may include information on an is unusable frequency or information on a TDM pattern. The number of pieces of the information on an unusable frequency or the information on a TDM pattern included in the proximity indication message may be one or plural. If the number of pieces of the information on an unusable frequency or the information on a TDM pattern is plural, the information on an unusable frequency and the information on a TDM pattern are paired and signaled.

The eNB 2250 includes a reception unit 2255, an ICO determination unit 2260, an IDC indication request determination unit 2265, and a transmission unit 2270.

The reception unit 2255 receives IDC indication information from the UE 2200.

For example, the reception unit 2255 may receive the IDC indication information from the UE 2200 through an IDC indication message having a new message format. If the IDC indication request of the eNB 2250 relates to a specific frequency band, the IDC indication message may also be configured so that the IDC indication is performed only on the specific frequency band. Here, the IDC indication message may include information on an unusable frequency band. The IDC indication message may further include information on a TDM pattern. The TDM pattern may be a DRX period, a DRX-active period, or a DRX subframe offset value. The IDC indication message may further include a measurement result of measurement including IDC interference or measurement not including IDC interference depending on a rule that the UE 2200 obtains measurement samples.

For another example, the reception unit 2255 may receive the IDC indication information from the UE 2200 through a measurement report message. If the IDC indication request of the eNB 2250 relates to a specific frequency band, the measurement report message may also be configured so that the IDC indication is performed only on the specific frequency band. The measurement report message may include not only a measurement result, but also is information on an unusable frequency or information on a TDM pattern. The number of pieces of the information on an unusable frequency or the information on a TDM pattern included in the measurement report message may be one or plural. If the number of pieces of the information on an unusable frequency or the information on a TDM pattern is plural, the information on an unusable frequency and the information on a TDM pattern are paired and signaled.

For yet another example, the reception unit 2255 may receive the IDC indication information from the UE 2200 through a proximity indication message used in a proximity indication operation. If the IDC indication request of the eNB 2250 relates to a specific frequency band, the proximity indication message may also be configured so that the IDC indication operation is performed only on the specific frequency band. Here, an identifier for distinguishing a proximity indication message for the existing CSG from the proximity indication message including the IDC indication information may be further included in the proximity indication message. When the IDC indication information is included in the proximity indication message, the proximity indication message may include information on an unusable frequency or information on a TDM pattern. The number of pieces of the information on an unusable frequency or the information on a TDM pattern included in the proximity indication message may be one or plural. If the number of pieces of the information on an unusable frequency or the information on a TDM pattern is plural, the information on an unusable frequency and the information on a TDM pattern are paired and signaled.

The ICO determination unit 2260 determines the most appropriate ICO operation based on the IDC indication information. Here, the ICO operation may be an FDM operation or a TDM operation. The FDM operation or the TDM operation may be an operation according to FIGS. 5 to 13.

The IDC indication request determination unit 2265 determines to request the UE 2200 to indicate information related to IDC conditions. For example, in the case where IDC triggering is fully performed by an implementation criterion within the UE 2200, when a point of time at which IDC triggering by which an ICO procedure is performed is performed is different from a point of time at which load balancing is applied, the IDC indication may be requested in order to check whether IDC conditions are valid or not even in a different point of time.

The transmission unit 2270 sends a message, requesting the IDC indication, to the UE 2200. The IDC indication request may be performed through MAC signaling or RRC signaling.

For example, the transmission unit 2270 may send a message, requesting the UE 2200 to perform the IDC indication for all frequency bands, to the UE 2200. Here, the eNB may indicate the on or off of the IDC indication request by using 1 bit added to the message (e.g., a MAC message or an RRC message) transmitted to the UE. When the 1 bit indicates the ON of the IDC indication request, the eNB requests the UE 220 to perform the IDC indication for all frequency bands.

For another example, the transmission unit 2270 may send a message, requesting the UE 2200 to perform the IDC indication for a specific frequency band, to the UE 2200. The message (e.g., a MAC message or an RRC message) including the IDC indication request includes an information element indicative of the specific frequency band. The specific frequency band may be a frequency band including a possibility that IDC interference may exist, that is, a frequency band having a possibility of an unusable frequency. The frequency band including a possibility that IDC interference may exist may be a frequency band including on-going IDC interference or both a frequency band including on-going IDC interference and a is frequency band including potential IDC interference existence.

Here, the transmission unit 2270 requests the IDC indication from the UE 2200 by using an EARFCN or an operating band.

Meanwhile, the transmission unit 2270 sends an ICO order to the UE 2200. For example, the ICO order may be transmitted through an RRC connection reestablishment message. The ICO operation may include the operation of a prohibition timer for prohibiting the transmission of an IDC indication message (or a measurement report message or a proximity indication message) for a specific time. Even in this case, an IDC indication operation according to the IDC indication request of the eNB 2250 may be permitted. Meanwhile, if the ICO operation determined by the eNB based on IDC indication information is identical with the existing ICO operation that is already being performed, the ICO ordering process may be omitted.

In accordance with the present invention, an eNB may request IDC-related information from UE.

In accordance with the present invention, UE may indicate IDC-related information for an eNB.

In accordance with the present invention, ICO-related information may be transmitted by using a proximity indication message or a measurement report message.

In accordance with the present invention, an operation may be performed so that the generation of IDC interference is avoided.

The above description is only an example of the technical spirit of the present invention, and those skilled in the art may change and modify the present invention in various ways without departing from the intrinsic characteristic of the present invention. Accordingly, is the disclosed embodiments should not be construed as limiting the technical spirit of the present invention, but should be construed as illustrating the technical spirit of the present invention. The scope of the technical spirit of the present invention is not restricted by the embodiments, and the scope of the present invention should be interpreted based on the appended claims. Accordingly, the present invention should be construed as covering all modifications or variations induced from the meaning and scope of the appended claims and their equivalents.

What is claimed is:

1. A method of user equipment controlling In-Device Coexistence (IDC) interference in a wireless communication system, the method comprising:
receiving an IDC indication request from an eNodeB (eNB) when a point of time at which an IDC indication for sending IDC-related information is triggered is different from a point of time at which load balancing is applied;
sending the requested IDC indication to the eNB; and
receiving an In-device Coexistence interference cOordination (ICO) operation order determined based on the IDC indication from the eNB.

2. The method of claim 1, wherein the IDC indication request includes 1 bit indicative of an ON or OFF of the IDC indication request for all frequency bands.

3. The method of claim 1, wherein the IDC indication request includes requesting the IDC indication for a specific frequency band including a possibility that IDC interference may exist.

4. The method of claim 3, wherein the IDC indication request is performed by using an E-UTRA Absolute Radio Frequency Channel Number (EARFCN) value corresponding to the specific frequency band including a possibility that IDC interference may exist or a number of an operating band corresponding to the specific frequency band including a possibility that IDC interference may exist.

5. A method of an eNB controlling In-Device Coexistence (IDC) interference in a wireless communication system, the method comprising:
determining whether or not to make an IDC indication request based on a point of time at which an IDC indication for sending IDC-related information is triggered is different from a point of time at which load balancing is applied;
requesting the IDC indication from User Equipment (UE) based on the determination;
receiving the requested IDC indication from the UE;
determining an appropriate ICO operation based on the IDC indication; and
sending an order for the determined ICO operation to the UE.

6. The method of claim 5, wherein the IDC indication request includes 1 bit indicative of an on or off of the IDC indication request for all frequency bands.

7. The method of claim 5, wherein the IDC indication request includes requesting the IDC indication for a specific frequency band including a possibility that IDC interference may exist.

8. The method of claim 7, wherein the IDC indication request is performed by using an E-UTRA Absolute Radio Frequency Channel Number (EARFCN) value corresponding to the specific frequency band including a possibility that IDC interference may exist or a number of an operating band corresponding to the specific frequency band including a possibility that IDC interference may exist.

9. The method of claim 5, further comprising checking whether IDC conditions are valid or not if the point of time at which the IDC indication is triggered is changed based on the ICO operation or checking whether there are changed conditions or not.

10. User equipment controlling In-Device Coexistence (IDC) interference in a wireless communication system, the UE comprising:
a reception unit configured to receive an IDC indication request from an eNB when a point of time at which an IDC indication for sending IDC-related information is triggered is different from a point of time at which load balancing is applied; and
a transmission unit configured to send the requested IDC indication to the eNB,
wherein the reception unit receives an In-device Coexistence interference Coordination (ICO) operation order determined based on the IDC indication from the eNB.

11. The user equipment of claim 10, wherein the IDC indication request includes 1 bit indicative of an on or off of the IDC indication request for all frequency bands.

12. The user equipment of claim 10, wherein the IDC indication request includes requesting the IDC indication for a specific frequency band including a possibility that IDC interference may exist.

13. The user equipment of claim 12, wherein the IDC indication request is performed by using an E-UTRA Absolute Radio Frequency Channel Number (EARFCN) value corresponding to the specific frequency band including a possibility that IDC interference may exist or a number of an operating band corresponding to the specific frequency band including a possibility that IDC interference may exist.

14. An eNodeB (eNB) controlling In-Device Coexistence (IDC) interference in a wireless communication system, the eNB comprising:
an IDC indication request determination unit configured to determine whether or not to make an IDC indication request based on a point of time at which an IDC indication for sending IDC-related information is triggered is different from a point of time at which load balancing is applied;
a transmission unit configured to request the IDC indication from User Equipment (UE) based on the determination;
a transmission unit configured to receive the requested IDC indication from the UE; and
an ICO determination unit configured to determine an appropriate In-device Coexistence interference Coordination (ICO) operation based on the IDC indication,
wherein the transmission unit sends an order for the determined ICO operation to the UE.

15. The eNB of claim 14, wherein the IDC indication request includes 1 bit indicative of an on or off of the IDC indication request for all frequency bands.

16. The eNB of claim 14, wherein the IDC indication request includes requesting the IDC indication for a specific frequency band including a possibility that IDC interference may exist.

17. The eNB of claim 16, wherein the IDC indication request is performed by using an E-UTRA Absolute Radio Frequency Channel Number (EARFCN) value corresponding to the specific frequency band including a possibility that IDC interference may exist or a number of an operating band corresponding to the specific frequency band including a possibility that IDC interference may exist.

18. The eNB of claim 14, wherein the IDC indication request determination unit further checks whether IDC conditions are valid or not if the point of time at which the IDC indication is triggered is changed based on the ICO operation or checking whether there are changed conditions or not.
